(19) United States
(12) Patent Application Publication
(10) Pub. No.: US 2011/0206973 A1
(43) Pub. Date: Aug. 25, 2011

(54) MULTI-LAYER MICROPOROUS MEMBRANES AND METHODS FOR MAKING AND USING SUCH MEMBRANES

(75) Inventors: Patrick Brant, Seabrook, TX (US); Derek W. Thurman, Houston, TX (US); Rui Zhao, Houston, TX (US); Koichi Kono, Saitama (JP); Kotaro Takita, Tochigi (JP); Junko Takita, Tochigi (JP)

(73) Assignee: TORAY TONEN SPECIALTY SEPARATOR GODO KAISHA, Tochigi (JP)

(21) Appl. No.: 13/123,553

(22) PCT Filed: Oct. 22, 2009
(86) PCT No.: PCT/US09/61667

§ 371 Date: Apr. 11, 2011

Related U.S. Application Data
(60) Provisional application No. 61/232,671, filed on Aug. 10, 2009.
(60) Provisional application No. 61/226,481, filed on Jul. 17, 2009.
(60) Provisional application No. 61/226,442, filed on Jul. 17, 2009.
(60) Provisional application No. 61/171,686, filed on Apr. 22, 2009.
(60) Provisional application No. 61/108,243, filed on Oct. 24, 2008.

(30) Foreign Application Priority Data
Dec. 22, 2008 (EP) 08172507.9
May 25, 2009 (EP) 09160968.5

(51) Int. Cl. H01M 2/16; B29C 44/04

(52) U.S. Cl. 429/145; 264/45.1

(57) ABSTRACT

A layered microporous polymeric membrane includes a first blend region having a thickness T1, a third blend region having a thickness T3, and a second blend region located between the first and third blend regions and having a thickness T2, wherein [(T1−T2)/T1]≧0.05 and [(T3−T2)/T3]≧0.05.

### CROSS-REFERENCE TO RELATED APPLICATIONS

This application claims priority from U.S. Prov. App. Ser. No. 61/108,243, filed 24 Oct. 2008; U.S. Prov. App. Ser. No. 61/171,686, filed 22 Apr. 2009; U.S. Prov. App. Ser. No. 61/226,442, filed 17 Jul. 2009; U.S. Prov. App. Ser. No. 61/226,481, filed 17 Jul. 2009, U.S. Prov. App. Ser. No. 61/232,671, filed 10 Aug. 2009, EP081725073.9 filed 22 Dec. 2008, EP09160968.5 filed 25 May 2009, the contents of each of which are incorporated by reference in their entirety.

### FIELD OF THE INVENTION

The invention relates to layered microporous membranes having regions comprising a blend of at least first and second polymer compositions. In some embodiments, the regions are blend regions that are located between one layer including the first polymer composition and a second layer that includes the second composition. The invention also relates to methods for making such a membrane and methods for using such a membrane, e.g., as a battery separator.

### BACKGROUND OF THE INVENTION

Multi-layer microporous polymeric membranes can be used as separators in primary and secondary batteries such as lithium ion primary and secondary batteries. For example, PCT patent publication W02008016174A1 discloses a multi-layer microporous membrane containing polyolefin and having a fibrous structure which provides microporosity. The publication discloses an extrudate produced by co-extruding a mixture of polymer and diluent, stretching the extrudate in at least one planar direction, and then removing the diluent to form the multi-layer microporous polymeric membrane. According to the disclosure, the fibrous structure results from the stretching of the extrudate, which produces a large number of fibrils. The fibrils form a three-dimensional irregularly connected network structure providing the membrane with microporosity.

Producing a microporous membrane having an increased number of layers (and optionally a fibrous structure) is desirable because it allows improved control over the balance of membrane properties such as meltdown temperature, shut down temperature, mechanical strength, porosity, permeability, etc. W02008016174A1 discloses that such membranes can be made by laminating three or more monolayer extrudates, or by coextruding three or more mixtures of polymer and diluent, followed by stretching the multi-layer extrudate to impart microporosity and then removing diluent to produce the membrane. Such coextrusion and lamination becomes increasingly complicated as the number of layers increases, particularly beyond three layers.

Stretching is generally accomplished using tenter-type stretching equipment having opposed continuous rails and clips movably connected to the rails for gripping the edges of the extrudate and translating the extrudate through the tenter equipment. Stretching at relative high rates and high magnifications can lead to film thickness non-uniformity and even film tearing. Moreover, the clips gripping the edges of the membrane damage the membrane, and the damaged portions of the membrane are then cut off and conducted away from the process, which reduces membrane yield.

Multilayer microporous membranes are generally also limited by the composition of individual layers that are extruded to form the multilayer extrudate. For example, in a conventional co-extrusion process for making liquid-permeable multilayer polymeric membranes, the co-extruded layers are separated by a thin blend region where diffusion has occurred. Such a two-layer co-extruded membrane is schematically represented along with a concentration profile of the membrane in FIG. 1. As FIG. 1 shows, such an extrudate 100 will have a first co-extruded layer 101 and a second co-extruded layer 102. The first co-extruded layer 101 has a composition, A. As depicted in the concentration profile, the concentration of A is essentially constant over the thickness of the layer 101. Likewise, co-extruded layer 102 has a composition, B, different from the composition of layer 101. Where the layers 101 and 102 meet during the co-extrusion process, a narrow blend region 103 is formed. The concentration of A diminishes over the thickness of the blend region 103 until the second co-extruded layer is reached.

Micrographs of a conventional two-layer coextruded PE/PP film show that a relatively narrow blend region is formed at the PE-PP interface. Such a blend region has a thickness of less than about 10 nm. Thus, forming relatively large blend regions and forming structures having a large number of layers by conventional coextrusion processes is difficult.

A process is therefore desired for producing a multi-layer microporous membrane having an increased number of membrane layers and/or blend regions with a reduced amount of extrudate stretching and at an acceptable.

### SUMMARY OF THE INVENTION

Embodiments of the invention are directed to structures resulting from application of layer multiplication methods to compositions including polymers and diluents. In one aspect, embodiments of the invention provide a layered microporous polymeric membrane comprising a first blend region having a thickness T1, a the third blend region having a thickness T3, and a second blend region located between the first and third blend regions and having a thickness T2; wherein [(T1−T2)/T1]≧0.05 and [(T3−T2)/T3]≧0.05.

In another aspect, embodiments of the invention provide a microporous membrane comprising a first blend region comprising a first polymer and a second polymer and having a first concentration profile of the first polymer that varies in the thickness direction of the first blend region; and a second blend region in surface contact with the first blend region and comprising the first polymer and the second polymer and having a second concentration profile of the first polymer, the second concentration varying in the thickness direction of the second blend region.

In another aspect, embodiments of the invention relate to a microporous membrane comprising a first polymer and a second polymer wherein the composition of the first polymer varies continuously in the thickness direction from a first surface of the film to a second surface of the film.

In still another aspect, embodiments of the invention relate to a method of making a microporous membrane. Such a method for making a microporous membrane comprises: manipulating a first layered article comprising first and second layers, wherein the first layer comprises a first diluent and a first polymer, wherein the second layer comprises a second diluent miscible with the first diluent and a second polymer different from the first polymer, to produce a second layered article having an increased number of layers including first and second adjacent blend regions that include the first polymer composition and the second polymer composition; and removing at least a portion of the first and second diluents from the second article to produce the microporous membrane.

Particular embodiments of the described method for producing a multi-layer microporous membrane include forming a layered article having a first thickness and comprising first and second layers, the first layer comprising a first polymer and at least a first diluent and the second layer comprising a second polymer and at least a second diluent miscible with the first diluent, the first diluent and second diluents being miscible with the first and second polymers and the first and second polymers being different polymers or combinations of polymers; manipulating the layered article to form a second layered article having a second thickness greater than the first thickness and an increased number of layers compared to the first layered article, and molding the second layered article to reduce the second thickness.

Embodiments of the invention also relate to a fibrous extrudate produced by these methods. Embodiment of the invention also further include removing at least a portion of the first and second diluents from the fibrous extrudate to produce a layered microporous membrane is also within the scope of the invention, as is the membrane so produced.

In some embodiments, the microporous membranes described herein can be used as battery separators to form a battery.

### BRIEF DESCRIPTION OF THE DRAWINGS

FIG. 1 schematic representation of a conventional cross-section of a co-extruded film.

FIG. 2 schematic representation of a cross-section of a film having blend regions according to an embodiment of the invention.

FIG. 3 schematic representation of a cross-section of a film having first and second blend layers that are in surface contact according to an embodiment of the invention.

FIG. 4 schematic representation of a cross-section of a film having first and second blend layers that are in surface contact according to an embodiment of the invention.

FIG. 5 schematic representation of a cross-section of a film having blend regions related by symmetry.

FIG. 6 schematic of a method of making a film according to embodiments of the invention.

FIG. 7 schematic representation of the formation of blend regions during layer multiplication.

FIGS. 8A and 8B schematic representation of the co-extrusion apparatus and die configuration in a layer multiplication process useful in the process of embodiments of the invention.

FIGS. 9-12 are micrographs of exemplary films according to the invention.

### DETAILED DESCRIPTION OF THE INVENTION

The invention is based in part on the discovery of multilayer microporous membranes having blend regions of different thickness in surface (e.g., face-to-face) contact with opposite sides of each interior layer.

As used herein, the term “layer” refers to 1) a region of the membrane where the concentration of a selected polymer component (or representation thereof) does not change over in the thickness direction of the membrane or 2) a region of the membrane in the thickness direction is bounded by an adjacent maximum and minimum in the concentration of the selected polymer component.

As used herein, the term “concentration profile” refers to the concentration of the selected polymer over the thickness of a layer. The concentration profile is said to “vary” when there is a change in the concentration of the selected polymer component in the thickness direction of the membrane that is greater than that observed for a 20 μm monolayer membrane of nominally the same average composition of the layer formed by extrusion molding. Of course, the concentration profile need not be continuous over the entire thickness of the layer and can be established by a trend, linear or otherwise, implied by at least three points distributed over the thickness of the layer. Concentration profiles are described in Zhao and Macosko, AIChE Journal, Vol. 53, No. 4, pp. 978-985 (April 2007).

Although the term “slope” generally applies to linear functions, a concentration profile need not be linear to have a slope. For the purposes of this disclosure, the slope of a particular concentration profile in a layer is determined by the adjacent maxima and minima that define a layer. If the concentration profile does not vary, then the slope is zero.

Figures and references thereto should be interpreted as schematic in nature. The relative size, number, and relationship of features of various figures is illustrative only and should not be interpreted as applying to any embodiment of the invention unless such an interpretation is explicitly required.

### [1] Composition and Structure of the Multi-Layer Microporous Membrane

In an embodiment, the membrane is a layered microporous membrane having a pair of outer layers (e.g., the first and fourth layers in a four-layer membrane) and at least two layers (called interior layers) located between the outer layers. The membrane includes blend regions of different thickness in surface contact with opposite surfaces of each interior layer. Optionally, the outer layers can be surface (or “skin”) layers of the membrane, i.e., there are no further layers between the outer layers and the surfaces of the membrane.

In an embodiment, one outer layer and at least one interior layer of the membrane comprise a first polymer. The first polymer can be, e.g., a single polymeric species (such as polyethylene of a particular molecular weight and molecular weight distribution) or a combination polymers. The average concentration of the first polymer in these layers (allowing for regions of, e.g., un-extracted diluent) does not increase or decrease over the thickness of the layer. The second outer layer and at least one interior layer comprise at least a second polymer, the second polymer being different than the first polymer. As in the case of the first polymer, the second polymer can be, e.g., a single polymeric species (such as polyethylene of a particular molecular weight and molecular weight distribution) or a combination polymers. In an embodiment, the second polymer is homogeneously distributed in the second outer layer and the interior layer containing the second polymer; consequently, like the first outer layer, the average concentration of the second polymer in the second outer layer (and in interior layer containing the second polymer) neither increases nor decreases over the thickness of the second layer. The first and second polymers can be combinations of polymers, for example, combinations of polyolefins such as combinations of one or more polyethylenes and polypropylenes. The membrane can optionally further comprise one or more additional interior layers, each containing third, fourth, fifth, etc. polymers or mixtures of polymers.

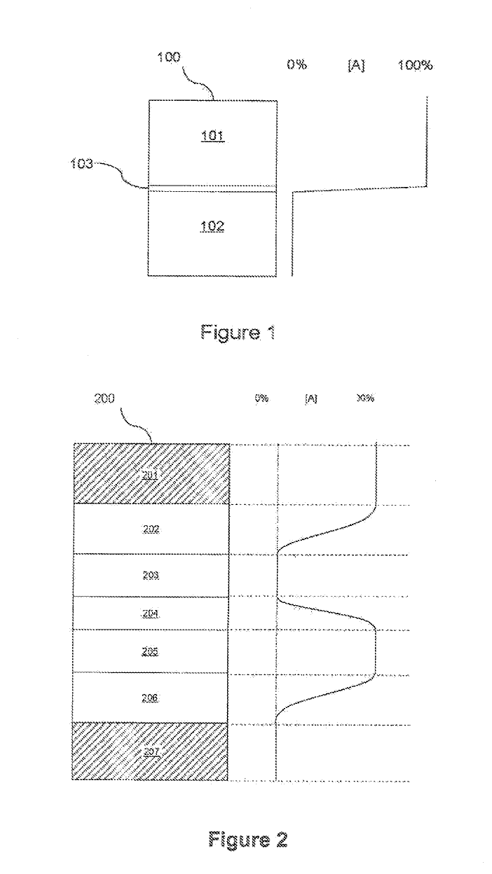

One such representative structure is schematically represented by the membrane or extrudate of FIG. 2. The membrane 200 has alternating layers of the first polymer comprising composition A (201, 205) and second polymer having composition B (203, 207). Layers 201, 205 have thicknesses L1, L3 respectively. Over the thicknesses of layers 201, 205 of the first polymer composition, the composition profile does not vary because interlayer diffusion has not reached these layers. Likewise the layers 203, 207 comprise the second polymer composition and have thicknesses L2, L4. Over the layers 203, 207, the amount of the first polymer composition reaches a minimum and does not vary. The layers 201, 205 of the first polymer composition and 203, 207 of the second polymer composition are separated by blend regions 202 (having a thickness “T1”), 204 (having a thickness “T2”), 206 having a thickness “T3”) formed by interdiffusion of compositions A and B during fabrication. Blend regions 202 and 206 have composition profiles characterized by a decrease in the concentration of A on moving in the thickness direction toward layers 203 and 207, respectively. Interfacial blend region 204 has a concentration profile characterized by an increase in the concentration of A on moving in the thickness direction toward layer 205. Some such membranes are described in copending U.S. Prov. Appl. No. 61/108,243, filed Oct. 24, 2008, and 61/171,686, filed Apr. 22, 2009, the disclosures of which are incorporated herein by reference in their entirety.

Some such membranes can be described by the relationship between the thicknesses of the blend regions. For example, where the membrane has at least four layers and at least three blend regions, the first and third blend regions, 202 and 206 can have approximately equal thickness. The second blend region 204 and has a thickness such that T2 is <T1 and T2 is <T3. In another embodiment, [(T1−T2)/T1]≧ about 0.05 and [(T3−T2)/T3]>0.05, for example [(T1−T2)/T1] can be in the range of about 0.05 to about 0.95 and [(T3−T2)/T3] can be in the range of about 0.05 to about 0.95, such as [(T1−T2)/T1] in the range of about 0.10 to about 0.75 and [(T3−T2)/T3] in the range of about 0.01 to about 0.75.

In an embodiment, the first and second polymers are not homogeneously distributed in the blend regions. For example as also shown in FIG. 2, in the case of the first blend region, the amount of first polymer decreases from a maximum value adjacent to the first layer to a minimum value adjacent to the second layer. Likewise, the amount of second polymer in the first blend region increases from a minimum amount adjacent to the first layer to a maximum amount adjacent to the second layer. In a particular blend region, the relative amounts of first and second polymer decrease at the same rates (but with opposite slope) in the thickness direction between adjacent layers containing first and second polymer respectively. In other words, the rate of increase in the concentration of the first polymer in the blend region can be the same as the rate of decrease in the concentration of the second polymer, or vice versa. The amount of concentration change in the thickness direction of the first or second polymer (the “concentration profile”) is not critical, and can have the profile of, for example, a line, a quadratic, a sine or cosine, an error function, a Gaussian, etc., including segments thereof and combinations of segments thereof.

The thickness of the blend regions is defined as the distance in the thickness direction of the membrane between which the concentration of the first polymer decreases from a maximum amount that is essentially the same as the concentration found in the first layer to an adjacent minimum amount that may be essentially the same as that in the adjacent second layer, based on the weight of first polymer in a layer comprising the first polymer that is in face-to-face contact with the blend region. Optionally, the most interior blend region (e.g., the second blend region in a four-layer membrane) has the smallest thickness. The thickness of a blend region is generally >25 nm, e.g., in the range of 25 nm to 5 μm, or 35 nm to 1 μm.

The layers containing the first polymer can all have approximately the same thickness, although this is not required. Likewise, the layers containing the second polymer can all have the same thickness, although this is not required. The thickness or thicknesses of the layers containing the first polymer can optionally be approximately the same as those of the layers containing the second polymer. All of the layers of the membrane can optionally be of approximately the same thickness, particularly where the membrane comprises about 20 layers. As the number of layers increases, the difference in thicknesses of the layers generally decreases. The thickness and relative thicknesses of the membrane's layers are not critical parameters. Generally, the thickness of a layer is greater than about two times the radius of gyration of the polymer (“Rg”) in the layer, e.g., in the range of 25 nm to 50 μm, e.g., 100 nm to 10 μm, or 250 nm to 1 μm. Rg can be determined from the equation

$$Rg = \frac{a \sqrt{N}}{6}$$

where “a” is the polymer's statistical segment length and N is the number of segments in the polymer based on a four-carbon repeat unit. The value of Rg can be determined by methods described in U.S. Pat. No. 5,710,219, for example. Layers and blend regions can be imaged (e.g., for the purpose of measuring thickness) using, e.g., TEM, as described in Chaffin, et al, Science 288, 2197-2190.

One skilled in the art will appreciate that extruded layers or layers derived from extruded layers, such as those described herein, may have imperfections, particularly in the thickness direction. For the purposes of this application, the layer thickness is defined as the mean layer thickness determined by selecting five equally-spaced, 50 μm-wide regions over a 1 mm length of the membrane and measuring the cross-sectional thickness at ten equally-spaced points within each of five 50 μm regions. Two layers are considered to have substantially the same thickness if their individual mean thicknesses are ≧1 μm and differ by less than 10%.

Four-layer and eight-layer membranes are examples of the invention, but the invention is not limited thereto. The number of interior layers in the membrane is ≧2, e.g., ≧4, or ≧16, or ≧32, or ≧64, such as in the range of 2 to 10⁶ layers, or 8 to 2048 layers, or 16 to 1024 layers; and the number of blend regions is ≧3, e.g., ≧5, or ≧15, or ≧31, or ≧63, such as in the range of 3 to (10⁶⁻¹) blend regions, or 7 to 2047 blend regions, or 15 to 1023 blend regions. In an embodiment, the membrane is a symmetric membrane comprising two outer layers that can be skin layers and an even number of interior layers disposed in pairs of layers, with (i) each layer of the pair having the same thickness and located equidistant from the membrane's symmetry axis and (ii) one layer of the pair comprising the first polymer and the other comprising a second polymer different from the first polymer. Optionally, the layers of the layer pair comprising the outer layers have the greatest thickness. The layers of the central pair of layers, located adjacent to and on either side of the membrane's symmetry plane have the smallest thickness.

In an embodiment, the symmetry plane bisects the center-most blend region in the membrane. Optionally, the membrane contains an odd number of blend regions. Optionally, blend region closest to the membrane's symmetry plane (which can, e.g., be bisected by the symmetry plane) has the smallest thickness among the blend regions. The remaining blend regions can be disposed as pairs of blend regions, with each blend region of the pair optionally being of approximately equal thickness and optionally being located approximately equidistant from the symmetry plane. Optionally, the blend regions adjacent to the outer pair of layers have the greatest thickness, with the pairs of blend regions closer to the membrane's symmetry plane having progressively smaller thicknesses.

As diffusion increases and the interfaces expand, the layers comprising the first polymer or the second polymer are incorporated into the blend regions. In some embodiments, the growth of the blend regions provide a membrane where the blend regions merge. The result is a membrane having at least first and second blend regions that are in surface contact and comprise the first and second polymers, wherein the concentration of at least one of the first or second polymers varies in the thickness direction of the blend region. Particular embodiments also include a first microlayer comprising the first polymer and a second microlayer comprising the second polymer, wherein the first and second blend regions are located between the first and second microlayers.

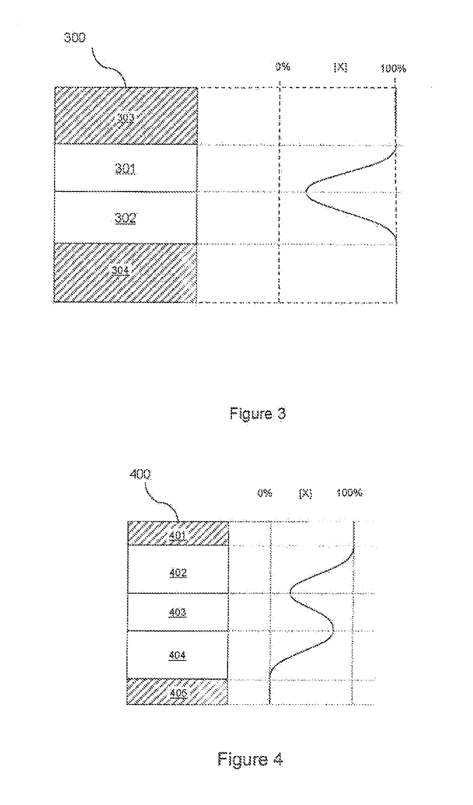

One such embodiment will now be described with reference to FIG. 3. In such an embodiment, interdiffusion of individual layers of the first polymer composition and the second polymer composition has occurred such that at least two blend regions 301, 302 in surface contact have evolved in the interior of the membrane 300. FIG. 3 also shows a general concentration profile of such an embodiment. The outer layers 303, 304 of membrane 300 have a composition profile of a component X, typically the first polymer composition, the second polymer composition or a representation thereof, that does not vary more than would be observed for a 20 μm monolayer membrane of nominally the same average composition of a layer of A or B formed by extrusion molding. Thus, where the first polymer composition forms outer layer 303, the concentration of the variable representing the first polymer composition does not change over the thickness of layer 303. As blend region 301 is reached, the concentration of the variable representing the first polymer composition begins to diminish and generally continues to diminish until a minimum is reached. The change in concentration, i.e., slope, of the variable representing the first polymer composition, is generally negative on moving from the boundary of layer 303 to blend region 302. In the blend region 302, the concentration of the variable representing the first polymer composition increases in the direction toward layer 304, i.e., the slope is positive. In this specific embodiment, a layer of the first polymer composition forms outer layer 304 where the concentration of the variable represents the first polymer composition.

Another exemplary embodiment of the invention is depicted in FIG. 4. Membrane 400 has outer layers 401 and 405, respectively. Optionally, as depicted in FIG. 4, layer 401 has a first polymer composition, and layer 405 has a second polymer composition that is different from the first polymer composition. Blend regions 402 and 403 are in surface contact and blend region 402 the value of the variable representing the first polymer composition decreases on moving in the thickness direction of the film toward blend region 403. The value of the variable representing the first polymer composition increases on moving from the side of blend region 403 adjacent blend region 402 toward blend region 404 where the value of the variable representing the first polymer composition begins to decrease until outer layer 405 is reached.

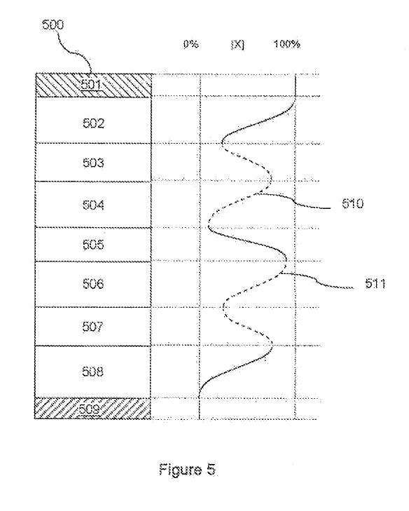

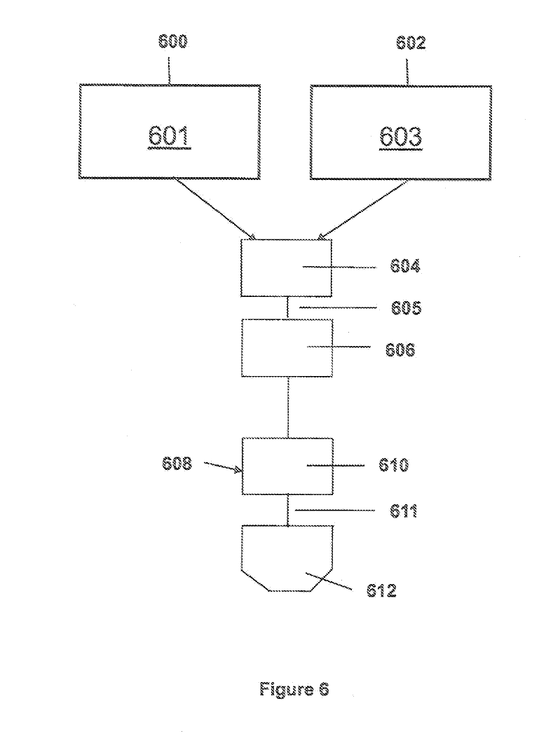

FIG. 5 exemplifies various arrangements of layers that can be present in particular embodiments of the membranes of the invention. Membrane 500 shows optional outer microlayers 501 and 509 and exemplary blend regions 502-508. In some embodiments, the thickness of a first blend region, e.g., blend region 502, is greater than the individual thicknesses of the optional outer microlayers 501 and 502. The concentration profile of blend region 502 has a negative slope, i.e., the concentration of the variable representing polymer A decreases on moving from the surface of layer 502 closest to the exterior surface of the membrane 500 toward the surface nearer the center of the membrane 500. The concentration profile of blend region 503 has a positive slope. The membrane 500 may also include a third blend region, such as blend region 504, whose concentration profile varies in the thickness direction, optionally with a negative slope.

In some embodiments, the third blend region of membrane 500 is in surface contact with the first blend region. For example, a first surface of first blend region 505 is in surface contact with second blend region 504. Third blend region 506 contacts a second surface of first blend region 505. In particular configurations, blend regions 504 and 506 each have a thickness greater than the thickness of the first blend region 505.

In other embodiments, a membrane such as membrane 500 has a third blend region, e.g., layer 503, in surface contact with the first blend region, e.g., layer 504, and the second and third blend regions, e.g., layers 505 and 503, each have a thickness that is less than the thickness of the first blend region 504.

In some embodiments, a plurality of blend regions is arranged as a series of repeating units, where each unit comprises at least a first blend region and at least a second blend region. A unit can further comprise one or more additional blend regions comprising first and second polymers. For example, a unit can have a plurality of first blend regions alternating with a plurality of second blend regions, with one or more additional blend regions optionally situated therebetween in, e.g., an A/B/A/B/A/B/A . . . or B/A/B/A/B/A1 . . . or A/R/B/A/R/B/A/R/B/A/R/B . . . or B/R/A/B/R/A/B/R/A . . . , where “A” represents the first unit of blend regions, “B” represents the second unit of blend regions, and “R” represents a third unit of one or more blend regions between first and second units. Additional layers, which need not be blend regions, can also be included if desired. As used herein, the term “repeating unit” refers to the repetition of a feature, or representation thereof, of one or more blend regions, e.g., layer thicknesses or concentration profiles. Such “repetition” may occur linearly reflecting a translational symmetry along the thickness direction of the membrane or may occur through one or more symmetry operations such as an inversion center or plane of reflection in a cross-section of the membrane. One such embodiment is shown in the membrane 500 of FIG. 5 where the exemplary repeating units 510, 511 (shown in dashed lines) are related through an inversion operation.

In an embodiment, the liquid-permeable membrane comprises pairs of microlayers, each having substantially the same thickness, e.g., ≦1.0 μm. Optionally, the liquid-permeable membrane has a symmetry plane parallel to the generally planar surfaces of the membrane and located, e.g., midway through the membrane in the thickness direction. Optionally, each microlayer in a pair of microlayers is disposed on opposite sides of the symmetry plane, e.g., substantially equidistant from the symmetry plane. In one example, referring to FIG. 5, layers 502 and 508 comprise a pair of microlayers having substantially the same thickness, while layers 504 and 506 form a second pair of microlayers, each having a thickness that is substantially the same as or less than that of the first pair of layers. The microlayers of the first pair are substantially equidistant from the liquid-permeable membrane's symmetry plane. The membrane's symmetry plane is located between (and substantially equidistant from) the microlayers of the second pair.

The number of layers in the membranes is not particularly limited. The liquid-permeable membrane can, e.g., comprise a number of blend regions ≧2, e.g., ≧4, or ≧16, or ≧32, or ≧64, such as in the range of 2 to 1.0×106 layers, or 8 to 2,048 layers, or 16 to 1,024 layers. In an embodiment, the membrane is a symmetric membrane comprising two outer layers that can be skin layers and a number of interior blend region pairs disposed therebetween, with (i) each layer of the pair having substantially the same thickness and located equidistant from the membrane's symmetry axis and optionally, (ii) one layer of each pair comprising a concentration, [A] (in wt. %), of the first polymer and the other comprising a concentration 100-[A] (in wt. %) of the first polymer.

In an embodiment, the liquid-permeable membrane's symmetry plane bisects the center-most layer in the membrane. Optionally, the membrane contains an odd number of blend regions. Optionally, the blend region closest to the membrane's symmetry plane (which can, e.g., be bisected by the symmetry plane) has the smallest thickness among the blend regions. The remaining blend regions can be disposed as pairs, with each blend region of the pair optionally being of substantially the same thickness and optionally being located substantially equidistant from the imaginary center-line of the membrane thickness. Optionally, the blend regions that are distal the center-line of the membrane are thicker than layers closer to the center-line. In particular embodiments, alternating blend regions will have a thickness less than each layer adjacent to it.

### [2] Materials Used to Produce the Microporous Membrane

The first and second polymers can be, e.g., independently selected polyolefins or mixtures of polyolefins. The membrane can be referred to as a “polyolefin membrane” when the membrane contains polyolefin. While the membrane can contain polyolefin only, this is not required, and it is within the scope of the invention for the polyolefin membrane to contain polyolefin and/or materials that are not polyolefin. In an embodiment the first polymer is polyethylene and the second polymer is polypropylene. The microporous membrane generally comprises the polymers or combination of polymers used to produce the membrane. A small amount of diluent or other species introduced during processing can also be present, generally in amounts less than about 1 wt. % based on the weight of the microporous membrane. A small amount of polymer Mw degradation might occur during processing, but this is acceptable. In an embodiment, molecular weight degradation during processing, if any, causes the value of MWD of the polymer in the membrane to differ from the MWD of the first polymer or second polymer used to produce the membrane by no more than about 5%, for example no more than about 1%, e.g. no more than about 0.1%.

Preferred polyolefins include homopolymers or copolymers of C2 to C40 olefins, preferably C2 to C20 olefins, more preferably a copolymer of an alpha-olefin monomer and another olefin or alpha-olefin comonomer (ethylene is defined to be an alpha-olefin for purposes of this invention). Examples of suitable olefins include ethylene, propylene, butene, isobutylene, pentene, isopentene, cyclopentene, hexene, isohexene, cyclohexene, heptene, isoheptene, cycloheptene, octene, isooctene, cyclooctene, nonene, cyclononene, decene, isodecene, dodecene, isodecene, 4-methyl-pentene-1,3-methyl-pentene-1,3,5,5-trimethyl hexene-1. Suitable comonomers also include dienes, trienes, and styrenic monomers, including but not limited to, styrene, alpha-methyl styrene, para-alkyl styrene (such as para-methyl styrene), hexadiene, norbornene, vinyl norbornene, ethylidene norbornene, butadiene, isoprene, heptadiene, octadiene, and cyclopentadiene. Preferred comonomers for the copolymer of ethylene include propylene, butene, hexene and/or octene.

Preferably, the polyolefin is or includes homopolyethylene, homopolypropylene, propylene copolymerized with ethylene and/or butene, ethylene copolymerized with one or more of propylene, butene or hexene, and optional dienes. Other preferred polyolefins include thermoplastic polymers such as ultra low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and blends of thermoplastic polymers and elastomers, such as, for example, thermoplastic elastomers and rubber toughened plastics.

Preferred metallocene catalyzed polyolefins include metallocene polyethylenes (mPE) and metallocene polypropylenes (mPP), and combinations or blends thereof. The mPE and mPP homopolymers or copolymers can be produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. Several commercial products produced with such catalyst/activator combinations are commercially available from ExxonMobil Chemical Company in Baytown, Tex. under the tradenames EXCEED™, ACHIEVE™ and EXACT™. For more information on the methods and catalysts/activators to produce such homopolymers and copolymers see PCT Pat. Pub. Nos. WO 94/26816; WO 94/03506; WO 92/00333; WO 91/09882; WO 94/03506; U.S. Pat. Nos. 5,153,157; 5,198,401; 5,240,894; 5,017,714; 5,324,800; 5,264,405; 5,096,867; 5,507,475; 5,055,438; EP 277,003; EP 277,004; EP 129,368; EP 520,732; EP 426 637; EP 573 403; EP 520 732; EP 495 375; EP 500 944; EP 570 982 and CA 1,268,753.

The total amount of the first polymer in the membrane can be in the range of 1 wt. % or more based on the weight of the membrane. For example, the total amount of the first polymer in the membrane can be in the range of from about 10 wt. % to about 90 wt. %, or from about 30 wt. % to about 70 wt. %, based on the weight of the microporous membrane. The total amount of the second polymer in the membrane is independently selected from the amount of first polymer. In an embodiment, the total amount of the second polymer in the membrane is in the range of 1 wt. % or more, based on the weight of the membrane. For example, the total amount of the second polymer in the membrane can be in the range of from about 10 wt. % to about 90 wt. %, or from about 30 wt. % to about 70 wt. %, based on the weight of the microporous membrane. In an embodiment, the membrane contains substantially equal amounts of the first and second polymers, e.g., both about 50 wt. %, based on the total weight of the membrane.

In an embodiment, the first polymer comprises a first polyethylene and/or a first polypropylene. The second polymer comprises a second polyethylene and/or a second polypropylene. The total amount of polyethylene in the first polymer (the first polyethylene) can be in the range of 3 wt. % to 100 wt. %, or 25 wt. % to 75 wt. %, for example, based on the weight of the first polymer. The total amount of polyethylene in the second polymer (the second polyethylene) is independently selected from the amount of polyethylene in the first polymer, and can be in the range of 2 wt. % to 100 wt. %, or 25 wt. % to 75 wt. %, for example, based on the weight of the second polymer.

The total amount of polypropylene in the first polymer (the first polypropylene), when present, can range from a low of about 5 wt. %, 10 wt. %, 15 wt. %, or 25 wt. % to a high of about 25 wt. %, 50 wt. %, 75 wt. %, or 90 wt. %, based on the weight of the first polymer. The total amount of polypropylene in the second polymer (the second polypropylene), when present, can range from a low of about 5 wt. %, 10 wt. %, 15 wt. %, or 25 wt. % to a high of about 25 wt. %, 50 wt. %, 75 wt. %, or 90 wt. %, based on the weight of the second polymer.

The total amount of polyethylene in the microporous membrane, when present, can range from a low of about 10 wt. %, 20 wt. %, 25 wt. %, or 30 wt. % to a high of about 35 wt. %, 50 wt. %, 75 wt. %, or 90 wt. %, based on the weight of the microporous membrane. The total amount of polypropylene in the microporous membrane can range from a low of about 10 wt. %, 20 wt. %, 25 wt. %, or 30 wt. % to a high of about 35 wt. %, 50 wt. %, 75 wt. %, or 90 wt. %, based on the weight of the microporous membrane.

In an embodiment, the multi-layer membrane contains four or more layers, with at least two layers produced from the first polymer (or combination of polymers) and at least two layers produced from a second polymer (or combination of polymers). The first and second polymers can each be, e.g., polyolefin. The first and second polymers can each be a combination (e.g., a mixture) of polyolefins. For example, the first polymer can comprise polyethylene, polypropylene, or both polyethylene and polypropylene. The second polymer is not the same as the first polymer, and optionally is not miscible in the first polymer. For example, when the first polymer is polyethylene, the second polymer can be polyethylene, provided the second polymer's polyethylene is not the same polyethylene (e.g., a different Mw and/or MWD) as the first polymer's polyethylene. When the first polymer is a combination of polymers, e.g., polyethylene and polypropylene, the second polymer can be (i) polyethylene, (ii) polypropylene, or (iii) a different combination of polypropylene and polyethylene (different polyethylene type and/or amount, different polypropylene type and/or amount, or some combination thereof) than that of the first polymer.

The total amount of first polymer in the microporous membrane is not critical, and is generally in the range of 1 wt. % or more based on the weight of the membrane. For example, the total amount of first polymer in the membrane can be in the range of from about 10 wt. % to about 90 wt. %, or from about 30 wt. % to about 70 wt. %, based on the weight of the microporous membrane. The total amount of second polymer in the microporous membrane is independently selected from the amount of first polymer, is not a critical parameter. In an embodiment, the total amount of second polymer in the membrane is in the range of 1 wt. % or more based on the weight of the membrane. For example, the total amount of second polymer in the membrane can be in the range of from about 10 wt. % to about 90 wt. %, or from about 30 wt. % to about 70 wt. %, based on the weight of the microporous membrane. In an embodiment, the membrane contains substantially equal amounts of first and second polymer, e.g., both about 50 wt. %, based on the weight of the membrane.

In an embodiment, the first polymer comprises a first polyethylene and/or a first polypropylene. The second polymer comprises a second polyethylene and/or a second polypropylene. The total amount of polyethylene in the first polymer (the first polyethylene) can be in the range of 0 wt. % to 100 wt. %, or 25 wt. % to 75 wt. %, for example, based on the weight of the first polymer. The total amount of polyethylene in the second polymer (the second polyethylene) is independently selected from the amount of polyethylene in the first polymer, and can be in the range of 0 wt. % to 100 wt. %, or 25 wt. % to 75 wt. %, for example, based on the weight of the second polymer.

The total amount of polypropylene in the first polymer (the first polypropylene) can be in the range of 0 wt. % to 100 wt. %, or 25 wt. % to 75 wt. %, for example, based on the weight of the first polymer. The total amount of polypropylene in the second polymer (the second polypropylene) is independently selected from the amount of polypropylene in the first polymer, and can be in the range of 0 wt. % to 100 wt. %, or 25 wt. % to 75 wt. %, for example, based on the weight of the second polymer.

The total amount of polyethylene in the microporous membrane is in the range of from about 0 wt. % to about 100 wt. %, for example from about 20 wt. % to about 80 wt. %, based on the weight of the microporous membrane. The total amount of polypropylene in the microporous membrane is in the range of 0 wt. % to 100 wt. %, for example from about 20 wt. % to about 80 wt. %, based on the weight of the microporous membrane.

The first and second polyethylene and the first and second polypropylene will now be described in more detail.

### The First Polyethylene

In an embodiment, the first polyethylene comprises a polyethylene having a weight averaged molecular weight (“Mw”) in the range of from about 1×10⁴ to about 1.5×10⁷, for example, from about 1×10⁵ to about 5×10⁶, e.g., from about 2×10⁵ to about 3×10⁶. Although it is not critical, the first polyethylene can have terminal unsaturation of, for example, two or more per 10,000 carbon atoms in the polyethylene. Optionally, the first polyethylene has a melting point ≦138° C., e.g., in the range of 122° C. to 138° C. Terminal unsaturation can be measured by, for example, conventional infrared spectroscopic or nuclear magnetic resonance methods. The first polyethylene can be one or more varieties of polyethylene, designated for example by “PE1,” “PE2,” “PE3,” etc. PE1 comprises polyethylene having an Mw ranging from about 1×10⁴ to about 1.5×10⁷. Optionally, the PE1 can be one or more of a high density polyethylene (“HDPE”), a medium density polyethylene, a branched low density polyethylene, or a linear low density polyethylene. Although it is not critical, the Mw of HDPE can be <1×10⁶, e.g., in the range of from about 1×10⁵ to about 1×10⁶, or from about 2×10⁵ to about 9×10⁵, or from about 3×10⁵ to about 8×10⁵. In an embodiment, PE1 is at least one of (i) an ethylene homopolymer or (ii) a copolymer of ethylene and a third α-olefin such as propylene, butene-1, hexene-1, etc., typically in a relatively small amount compared to the amount of ethylene. Such a copolymer can be produced using a single-site catalyst. In an embodiment, the first polymer comprises PE1.

In an embodiment, the first polyethylene comprises PE2. PE2 comprises polyethylene having an Mw≧1×10⁶. For example, PE2 can be an ultra-high molecular weight polyethylene (“UHMWPE”). In an embodiment, PE2 is at least one of (i) an ethylene homopolymer or (ii) a copolymer of ethylene and a fourth α-olefin which is typically present in a relatively small amount compared to the amount of ethylene. The fourth α-olefin can be, for example, one or more of propylene, butene-1, pentene-1, hexene-1,4-methylpentene-1, octene-1, vinyl acetate, methyl methacrylate, or styrene. Although it is not critical, the Mw of PE2 can be in the range of from about 1×10⁶ to about 15×10⁶, or from about 1×10⁶ to about 5×10⁶, or from about 1×10⁶ to about 3×10⁶.

In an embodiment, the first polyethylene comprises PE3. PE3 comprises a low melting point polyethylene homopolymer or copolymer having a Tm in the range of from 115.0° C. to 130.0° C., and an Mw in the range of from 5.0×10³ to 4.0×10⁵. Some useful polyethylene homopolymers and copolymers have an Mw in the range of from 8.0×10³ to 2.0×10⁵. In one embodiment, the polyethylene homopolymer or copolymer has an Mw in the range of from 1.0×10⁴ to 1.0×10⁵ or from 1.0×10⁴ to 7.0×10⁴. Optionally, the ethylene-based polymer has an MWD≦50, for example, in the range of from 1.5 to 20, from about 1.5 to about 5, or from about 1.8 to about 3.5.

In particular embodiments, the low melting point polyethylene is copolymer of ethylene and a comonomer such as α-olefin. The comonomer is generally present in a relatively small amount compared to the amount of ethylene. For example, the comonomer amount is generally less than 10% by mol, based on 100% by mol, of the copolymer, such as from 1.0% to 5.0% by mol. The comonomer can be, for example, one or more of propylene, butene-1, pentene-1, hexene-1,4-methylpentene-1, octene-1, vinyl acetate, methyl methacrylate, styrene, or other monomers, particularly hexene-1 or octene-1. Such a copolymer can be produced using any suitable catalyst, including a single-site catalyst. For example, the polymer can be produced according to the methods disclosed in U.S. Pat. No. 5,084,534 (such as the methods disclosed therein in examples 27 and 41), which is incorporated by reference herein in its entirety.

In an embodiment, the first polyethylene comprises PE1, PE2, PE3 or combinations thereof. In this case, the amount of PE2 and/or PE3 in the first polyethylene can be in the range of from greater than 0 wt. % to less than 100 wt. %, for example from about 25 wt. % to about 75 wt. %, based on the weight of the first polyethylene.

### The Second Polyethylene

The second polyethylene can comprise PE1, PE2, PE3 or combinations thereof. When the second polyethylene comprises a combination of PE1 and PE2 and/or PE3, the amount of the PE2 and/or PE3 in the first polyethylene can be in the range of from greater than 0 wt. % to less than 100 wt. %, for example, from about 25 wt. % to about 75 wt. %, based on the weight of the second polyethylene.

In one embodiment, the first and/or second polyethylene has one or more of the following independently-selected features:
(1) The first polyethylene comprises PE 1, optionally including PE3.
(2) The first polyethylene consists essentially of, or consists of, PE1.
(3) The first polyethylene comprises PE2, optionally including PE3.
(4) The first polyethylene consists essentially of, or consists of, PE2.
(5) The first polyethylene comprises both PE1 and PE2, optionally including PE3.
(6) The first polyethylene consists essentially of, or consists of, PE1 and PE2.
(7) PE2 of the first polyethylene is UHMWPE.
(8) PE1 is HDPE.
(9) PE1 has a molecular weight distribution (“MWD” defined as Mw/Mn) in the range of from about 1 to about 100, or about 2 to about 15, or from 4 to about 12.
(10) PE2 has an MWD in the range of about 1 to 100, e.g., in the range of about 2 to 8.

### The First Polypropylene

The first polypropylene can be, for example, “PP1,” which comprises one or more of (i) a propylene homopolymer or (ii) a propylene copolymer. The propylene copolymer can be a random or block copolymer, produced from, e.g., ethylene, butene-1, pentene-1, hexene-1,4-methylpentene-1, octene-1, vinyl acetate, methyl methacrylate, and styrene, etc.; and/or diolefins such as butadiene, 1,5-hexadiene, 1,7-octadiene, 1,9-decadiene, etc. The amount of these species in the copolymer is preferably in a range that does not adversely affect properties of the multi-layer microporous membrane such as heat resistance, compression resistance, heat shrinkage resistance, etc. For example, the amount can be less than 10 wt. % based on the weight of the copolymer. Optionally, PP1 has one or more of the following properties: (i) the PP1 has an Mw in the range of from about 1×10⁴ to about 4×10⁶, or from about 3×10⁵ to about 3×10⁶; (ii) the PP1 has an MWD ranging from about 1.01 to about 100, or from about 1.1 to about 50; (iii) the PP1 is isotactic; (iv) the PP1 has a heat of fusion “ΔHm” (measured by a differential scanning calorimeter (DSC) according to JIS K7122) of at least about 90 Joules/gram (J/g), for example from about 100 to about 120 J/g; (v) the PP1 has a melting peak (second melt) of at least about 160° C., (vi) the PP1 has a Trouton's ratio of at least about 15 when measured at a temperature of about 230° C. and a strain rate of 25 sec⁻¹; and/or (vii) the PP1 has an elongational viscosity of at least about 50,000 Pa sec at a temperature of 230° C. and a strain rate of 25 sec⁻1. In an embodiment, the ΔHm of the polypropylene is 95 J/g or more, or 100 J/g or more, or 110 J/g or more, or 115 J/g or more.

In one embodiment, PP1 has one or more of the following characteristics: an Mw≧1×10⁵, e.g., in the range of from about 3×10⁵ to about 1×10⁷, and a ΔHm of 90 J/g or more, for example from about 95 to about 125 J/g, e.g., 110 J/g to 120 J/g, and an MWD of at least 1.5, for example, from about 2 to about 50 or about 3 to about 6. As long as the above conditions of the Mw and the ΔHm are met, the type of the polypropylene selected for PP1 is not particularly critical, but it may be a propylene homopolymer, a copolymer of propylene and the other α-olefin, or a mixture thereof, the homopolymer being preferable.

### The Second Polypropylene

The second polypropylene can comprise PP1. In some embodiments, the second polypropylene (“PP2”) comprises polypropylene homopolymer or copolymer having an MFR≧2.0×10², such as >3.0×10², a Tm in the range of 85.0° C. to 130.0° C., and a Te—Tm<10° C. Optionally, PP2 has an MFR≧3.5×10² such as ≧4.5×10², e.g., in the range of from 5.0×10² to 4.0×10³, such as 5.5×10² to 3.0×10³; and a Tm in the range of 95.0° C. or 105.0° C. or 110.0° C. or 115.0° C. or 120.0° C. to 123.0° C. or 124.0° C. or 125.0° C. or 127.0° C. or 130.0° C. Optionally, PP2 has an Mw in the range of 1.0×10⁴ to 2.0×10⁵, such as from 1.5×10⁴ to 5.0×10⁴; an MWD≦50.0 in the range of from 1.4 to 20, e.g., 1.5 to 5.0; a ΔHm≧40.0 J/g, e.g., in the range of 40.0 J/g to 85.0 J/g, such as in the range of 50.0 J/g to 75.0 J/g; a density in the range of from 0.850 g/cm³ to 0.900 g/cm³, such as from 0.870 g/cm³ to 0.900 g/cm³ or 0.880 g/cm³ to 0.890 g/cm³; a crystallization temperature (“Tc”) in the range of from 45° C. or 50° C. to 55° C. or 57° C. or 60° C. Optionally, PP2 has a single-peak melting transition as determined by DSC, with no significant shoulders.

In an embodiment, PP2 is a copolymer of propylene-derived units and ≦10.0 mol. %, e.g., 1.0 mol. % to 10.0 mol. %., of units derived from one or more comonomers such as polyolefin, such as one or more units derived from ethylene and/or one or more C₄-C₁₂ α-olefins. The term “copolymer” includes polymers produced using one comonomer species and those produced using two or more comonomer species, such as terpolymer. Optionally, PP2 is a polypropylene copolymer having a comonomer content in the range of from 3.0 mol. % to 15 mol. %, or 4.0 mol. % to 14 mol. %, e.g., from 5.0 mol. % to 13 mol. %, such as from 6.0 mol. % to 10.0 mol. %. Optionally, when more than one comonomer is present, the amount of a particular comonomer is <1.0 mol. % and the combined comonomer content is 1.0 mol. %. Non-limiting examples of suitable copolymers include propylene-ethylene, propylene-butene, propylene-hexene, propylene-hexene, propylene-octene, propylene-ethylene-octene, propylene-ethylene-hexene and propylene-ethylene-butene polymers. In a particular embodiment, the comonomer comprises hexene and/or octene.

In an embodiment, PP2 is a copolymer of propylene and at least one of ethylene, octene, or hexene comonomer, wherein PP2 has an Mw in the range of from 1.5×10⁴ to 5.0×10⁴, and an MWD in the range of from 1.8 to 3.5, a Tm in the range of 100.0° C. to 126.0° C., and a Te-Tm in the range of 2.0° C. to 4.0° C.

PP2 can be produced, e.g., by any convenient polymerization process. Optionally, the PP2 is produced in a single stage, steady state polymerization process conducted in a well-mixed continuous feed polymerization reactor. The polymerization can be conducted in solution, although other polymerization procedures such as gas phase, supercritical, or slurry polymerization, which fulfill the requirements of single stage polymerization and continuous feed reactors, may also be used. PP2 can be prepared by polymerizing a mixture of propylene and optionally one or more other α-olefins in the presence of a chiral catalyst (e.g., a chiral metallocene).

The PP2 can be made in a polymerization process using a Ziegler-Natta or single-site polymerization catalyst. Optionally, the polypropylene is produced in a polymerization process using a metallocene catalyst. For example, PP2 can be produced according to the methods disclosed in U.S. Pat. No. 5,084,534 (such as the methods disclosed therein in examples 27 and 41), which is incorporated by reference herein in its entirety. In an embodiment, the second polymer contains one or more of PP1, PP2, PE1, PE2, and PE3, provided the second polymer is a different polymer or combination of polymers than the first polymer.

While the microporous membrane of the invention can contain copolymers, inorganic species (such as species containing silicon and/or aluminum atoms), and/or heat-resistant polymers such as those described in PCT Pat. Pub. WO 2008/016174, these are not required. In an embodiment, the multi-layer membrane is substantially free of such materials. Substantially free in this context means the amount of such materials in the microporous membrane that is less than about 1 wt. %, for example, less than about 0.1 wt. %, or less than about 0.01 wt. %, based on the total weight of the microporous membrane.

### Methods for Characterizing the First and Second Polymers

Tm is measured in accordance with JIS K7122. A polymer sample (0.5-mm-thick molding melt-pressed at 210° C.) is placed at ambient temperature in a sample holder of a differential scanning calorimeter (Pyris Diamond DSC available from Perkin Elmer, Inc.), heat-treated at 230° C. for 1 minute in a nitrogen atmosphere, cooled to 30° C. at 10° C./minute, kept at 30° C. for 1 minute, and heated to 230° C. at a speed of 10° C./minute. Tm is defined as the temperature of the greatest heat absorption within the range of melting as determined from the DSC curve. Polymers may show secondary melting peaks adjacent to the principal peak, and or the end-of-melt transition, but for purposes herein, such secondary melting peaks are considered together as a single melting point, with the highest of these peaks being considered the Tm.

Mw and MWD are determined using a High Temperature Size Exclusion Chromatograph, or “SEC”, (GPC PL 220, Polymer Laboratories), equipped with a differential refractive index detector (DRI). The measurement is made in accordance with the procedure disclosed in Macromolecules, Vol. 34, No. 19, pp. 6812-6820 (2001). Three PLgel Mixed-B columns (available from Polymer Laboratories) are used for the Mw and MWD determination. For polyethylene, the nominal flow rate is 0.5 cm³/min; the nominal injection volume is 300 μL; and the transfer lines, columns, and the DRI detector are contained in an oven maintained at 145° C. For polypropylene, the nominal flow rate is 1.0 cm³/min; the nominal injection volume is 300 μL; and the transfer lines, columns, and the DRI detector are contained in an oven maintained at 160° C.

The GPC solvent used is filtered Aldrich reagent grade 1, 2,4-Trichlorobenzene (TCB) containing approximately 1,000 ppm of butylated hydroxy toluene (BHT). The TCB was degassed with an online degasser prior to introduction into the SEC. The same solvent is used as the SEC eluent. Polymer solutions were prepared by placing dry polymer in a glass container, adding the desired amount of the TCB solvent, and then heating the mixture at 160° C. with continuous agitation for about 2 hours. The concentration of polymer solution was 0.25 to 0.75 mg/ml. Sample solutions are filtered off-line before injecting to GPC with 2 μm filter using a model SP260 Sample Prep Station (available from Polymer Laboratories).

The separation efficiency of the column set is calibrated with a calibration curve generated using seventeen individual polystyrene standards ranging in Mp (“Mp” being defined as the peak in Mw) from about 580 to about 10,000,000. The polystyrene standards are obtained from Polymer Laboratories (Amherst, Mass.). A calibration curve (logMp vs. retention volume) is generated by recording the retention volume at the peak in the DRI signal for each PS standard and fitting this data set to a 2nd-order polynomial. Samples are analyzed using IGOR Pro, available from Wave Metrics, Inc.

CDBI is defined as the percent of polyethylene copolymer whose composition is within 50% of the median comonomer composition in the polyethylene's composition distribution. The “composition distribution” can be measured according to the following procedure. About 30 g of the copolymer is cut into small cubes about ⅛ inch per side. These cubes are introduced into a thick walled glass bottle closed with a screw cap along with 50 mg of Irganox 1076, an antioxidant commercially available from Ciba-Geigy Corporation. Then, 425 ml of hexane (a principle mixture of normal and iso isomers) is added to the contents of the bottle and the sealed bottle is maintained at about 23° C. for about 24 hours. At the end of this period, the solution is decanted and the residue is treated with additional hexane for an additional 24 hours. At the end of this period, the two hexane solutions are combined and evaporated to yield a residue of the copolymer soluble at 23° C. To the residue is added sufficient hexane to bring the volume to 425 mL and the bottle is maintained at about 31° C. for 24 hours in a covered circulating water bath. The soluble copolymer is decanted and the additional amount of hexane is added for another 24 hours at about 31° C. prior to decanting. In this manner, fractions of the copolymer component soluble at 40° C., 48° C., 55° C., and 62° C. are obtained at temperature increases of approximately 8° C. between stages. Increases in temperature to 95° C. can be accommodated if heptane instead of hexane is used as the solvent for temperatures above 60° C. The soluble copolymer fractions are dried, weighed and analyzed for composition, as, for example, by weight percent ethylene content. Soluble fractions obtained from samples in the adjacent temperature ranges are the “adjacent fractions.” A copolymer is said to have a “narrow compositional distribution” when at least 75 wt. % of the copolymer is isolated in two adjacent fractions, each fraction having a composition difference of no greater than 20% of the copolymer's average wt. % monomer content.

The Mw and Mn of the polypropylene are determined by the method disclosed in PCT Pat. Pub. W02007/132942, which is incorporated by reference herein in its entirety.

The polypropylene's ΔHm is determined by the methods disclosed in PCT Pat. Pub. W02007/132942, which is incorporated by reference herein in its entirety.

Meso pentad fraction can be determined from 13 C NMR data obtained at 100 MHz at 125° C. on a Varian VXR 400 NMR spectrometer. A 90° C. pulse, an acquisition time of 3.0 seconds, and a pulse delay of 20 seconds are employed. The spectra are broad band decoupled and acquired without gated decoupling. Similar relaxation times and nuclear Overhauser effects are expected for the methyl resonances of polypropylenes, which are generally the only homopolymer resonances used for quantitative purposes. A typical number of transients collected is 2,500. The sample is dissolved in tetrachlorethane-d₂ at a concentration of 15% by weight. All spectral frequencies are recorded with respect to an internal tetramethylsilane standard. In the case of polypropylene homopolymer, the methyl resonances are recorded with respect to 21.81 ppm for mmmm, which is close to the reported literature value of 21.855 ppm for an internal tetramethylsilane standard. The pentad assignments used are well established.

The amount of extractable species (such as relatively low molecular weight and/or amorphous material, e.g., amorphous polyethylene) is determined by solubility in xylene at 135° C., according to the following procedure. Weigh out 2 grams of sample (either in pellet or ground pellet form) into 300 ml conical flask. Pour 200 ml of xylene into the conical flask with stir bar and secure the flask on a heating oil bath. Turn on the heating oil bath and allow melting of the polymer by leaving the flask in oil bath at 135° C. for about 15 minutes. When melted, discontinue heating, but continue stirring through the cooling process. Allow the dissolved polymer to cool spontaneously overnight. The precipitate is filtered with Teflon filter paper and then dried under vacuum at 90° C. The quantity of xylene soluble is determined by calculating the percent by weight of total polymer sample (“A”) less precipitate (“B”) at room temperature [soluble content=((A−B)/A)×100].

### The First and Second Diluents

The microporous membrane is produced by combining the first polymer and at least a first diluent to produce a first mixture and the second polymer with at least a second diluent to produce a second mixture. A first layered article (e.g., an extrudate) is produced from the mixtures comprising at least one layer comprising the second layer. The membrane can be produced by manipulating the layered article to form a second layered article having a second thickness greater than the first thickness and an increased number of layers compared to the first layered article; molding the second layered article to reduce the second thickness; and removing at least a portion of the first and second diluents from the molded second layered article to produce the multi-layer microporous membrane. The first and second diluents are miscible. Optionally, the first and second diluents are capable of dispersing, dissolving, or forming a slurry with the first and second polymers, e.g., the first and second diluents can be solvents for the first and second polymers. In this case, the diluents may be referred to as “membrane-forming” solvents. The first diluent can be the same as the second diluent

In an embodiment the first and second diluents is a solvent for polyethylene and/or polypropylene, such as liquid paraffin. The first and second diluents can be selected from among those described in PCT Publication W02008/016174, which is incorporated by reference herein in its entirety. The diluents can also be selected from among those described in U.S. Published Patent Application No. 2006/0103055, i.e., diluents that undergo a thermally-induced liquid-liquid phase separation at a temperature not lower than the polymer's crystallization temperature.

### [3] Methods for Producing the Microporous Membrane

In an embodiment, the first and second polymers are produced from resins of the polymers described in the preceding section, for example, resins of PE1, PE2, and/or PP1. The first polymer is combined with at least a one first diluent to form a first mixture and the second polymer is combined with at least a second diluent to form a second mixture. A first layered article having at least two layers is formed from the first and second mixtures, e.g., by extrusion, coextrusion, or lamination, wherein the first layered article comprises at least one layer containing the first mixture and a second layer containing the second mixture.

In the description that follows, the production of the first layered article will be described in terms of coextrusion, but the production method is not limited thereto. Other methods, including conventional methods such as casting and lamination can be used.

In one embodiment, microporous membrane is produced by:
(1) combining a first polymer and at least one first diluent to form a first mixture, and combining at least one second polymer and at least a second diluent miscible with the first diluent, the first diluent and second diluents being miscible with the first and second polymers;
(2) coextruding the first and second mixtures through a die to form a first layered extrudate having a first thickness;
(3) manipulating the first layered extrudate to form a second layered extrudate having a second thickness greater than the first thickness and an increased number of layers compared to the first layered extrudate;
(4) molding the second layered extrudate to reduce the second thickness, e.g., to about the first thickness or less; and
(5) removing at least a portion of the diluent from the molded second layered extrudate to produce the multi-layer microporous membrane. The time duration for the forming, manipulating, or molding is not critical. For example, each of the forming, manipulating, and molding can be conducted for a time in the range of 0.3 seconds to 100 seconds.

In addition to these steps, one or more optional cooling steps (2a) can be conducted at one or more points following step (2), an optional step (4a) for stretching the extrudate can be conducted between steps (4) and (5), an optional step (5a) for drying the membrane can be conducted after step (5), an optional step (6) for stretching the microporous membrane can be conducted following step (5), and one or more optional thermal treatment steps (7) can be conducted following step (5). Unless otherwise noted, the order of the optional steps is not critical.

### 1. Preparation of the First and Second Mixtures

### (A) Preparation of First Mixture

The first polymer comprises polymer resins as described above, e.g., one or more of PE1 and PE2 and PP1, which can be combined, for example, by dry mixing or melt blending with an the first diluent to produce the first mixture. The first mixture can contain additives such as, for example, one or more antioxidants. In an embodiment, the amount of such additives does not exceed about 1 wt. % based on the weight of the first mixture. The choice of first diluent, mixing conditions, extrusion conditions, etc. can be the same as those disclosed in PCT Publication WO 2008/016174, for example.

The amount of first polymer in the first mixture can be in the range of from 25 wt. % to about 99 wt. %, e.g., about 5 wt. % to about 40 wt. %, or 15 wt. % to about 35 wt. %, based on the combined weight of the first polymer and diluent in the first mixture.

### (B) Preparation of Second Mixtures

The second mixture can be prepared by the same method used to prepare the first mixture. For example, the second mixture can be prepared by melt-blending the polymer resins with a second diluent. The second diluent can be selected from among the same diluents as the first diluent. The second diluent can be the same as the first diluent, and must be compatible with the first diluent.

The amount of second polymer in the second mixture can be in the range of from 25 wt. % to about 99 wt. %, e.g., about 5 wt. % to about 40 wt. %, or 15 wt. % to about 35 wt. %, based on the combined weight of the second polymer and diluent. The first polymer can be combined with the first diluent and the second polymer can be combined with the second diluent at any convenient point in the process, e.g., before or during extrusion.

### 2. Extrusion

In an embodiment, the first mixture is coextruded with the second mixture to make a first layered extrudate of first thickness, having a planar surface of a first extrudate layer (formed from the first mixture) which is separated from a planar surface of a second extrudate layer (formed from the second mixture) by an interfacial layer containing the first polymer, the second polymer, the first diluent and the second diluent. The choice of die or dies and extrusion conditions can be the same as those disclosed in PCT Publication WO 2008/016174, for example. The first and second mixtures are generally exposed to an elevated temperature during extrusion (the “extrusion temperature”). For example, the extrusion temperature is ≧ the melting point (“Tm”) of the polymer in the extrudate (first polymer or second polymer) having the higher melting point. In an embodiment, the extrusion temperature is in the range of Tm+10° C. to Tm+120° C., e.g., in the range of about 170° C. to about 230° C.

In continuous and semi-continuous processing, the direction of extrusion (and subsequent processing of the extrudates and membrane) is called the machine direction, or “MD”. The direction perpendicular to both the machine direction and the thickness of the extrudate (and membrane) is called the transverse direction, or “TD”. The planar surfaces of the extrudate (e.g., the top and bottom surfaces) are defined by planes containing MD and TD.

While the extrusion can be used to make membranes having two layers, the extrusion step is not limited thereto. For example, a plurality of dies and/or die assemblies can be used to produce a first layered extrudate having four or more layers using the extrusion methods of the preceding embodiments. In such a first layered extrudate, each outer or interior layer can be produced using either the first mixture and/or the second mixture.

One embodiment for making the first layered extrudate is illustrated schematically in FIG. 1. First and second mixtures (100 and 102) are conducted to a multi-layer feedblock 104. Typically, melting and initial feeding is accomplished using an extruder for each mixture. For example, first mixture 100 can be conducted to an extruder 101 and second mixture 102 can be independently conducted to a second extruder 103. The multi-layer extrudate 105 is conducted away from feedblock 104. Multi-layer feedblocks are conventional, and are described, for example, in U.S. Pat. Nos. 6,827,886; 3,773,882; and 3,884,606 which are incorporated herein by reference in their entirety. While the first layered extrudate and the microporous membrane can contain copolymers, inorganic species (such as species containing silicon and/or aluminum atoms), and/or heat-resistant polymers such as those described in PCT Publication WO 2008/016174, these are not required. In an embodiment, the first layered extrudate and membrane is substantially free of such materials. Substantially free in this context means the amount of such materials in the microporous membrane is less than about 1 wt. %, for example less than 0.1 wt. %, e.g. less than 0.01 wt. %, based on the total weight of the polymer used to produce the extrudate.

### 3. Forming the Second Layered Extrudate

Any method capable of producing a second layered extrudate having a second thickness greater than the first thickness of the first layered extrudate and a greater number of layers than the first layered extrudate can be used to produce the second extrudate. For example, the first extrudate can be cut into two or more sections (e.g., along MD), with the sections then stacked in face-to face contact. Alternatively, the first extrudate can be folded (e.g., along MD) one or more times placing the folds of the first extrudate into face-to-face contact. Increasing the thickness of the first extrudate and the number of layers thereof to produce the second extrudate can be called “layer multiplication”. Conventional layer multiplication equipment is suitable for the layer multiplication step of the invention, such as that described in U.S. Pat. Nos. 5,202,074 and 5,628,950 which are incorporated by reference herein in their entirety. Unlike the conventional layer multiplication process, the layer multiplication step of the invention involves producing extrudates containing polymer and a significant amount of first and/or second diluent, e.g., greater than 1 wt % or greater than 5 wt. % based on the combined weight of the polymers and the diluents). Since the diluent is compatible with (or a good solvent for) both the first and second polymers, as described above, combining the first section of the first extrudate with the second section of the first extrudate produces a broader or blend region located therebetween, compared to the blend region created in the absence of diluent for the same interfacial contact time. The blend region results from the inter-diffusion of the first and second polymer in the presence of the first and second diluents under layer multiplication conditions.

In an embodiment, the first extrudate is exposed to an elevated temperature during layer multiplication (the “layer multiplication temperature”). For example, the layer multiplication temperature is ≧Tm of the polymer in the extrudate having the highest melting point. In an embodiment, the layer multiplication temperature is in the range of Tm+10° C. to Tm+120° C. In an embodiment, the extrudate is exposed to a temperature that is the same as (+/−5° C.) as the extrusion temperature.

Referring again to FIG. 1, a conventional layer multiplier 106 can be used to 20 separate first and second portions of the first layered extrudate along the machine direction on a line perpendicular to the planar surface of the extrudate. The layer multiplier redirects and “stacks” one portion aside or atop the second in face-to-face contact to multiply the number of layers extruded and produce the second layered extrudate. Optionally, an asymmetric multiplier can be used to introduce layer thickness deviations throughout the stack of layers in the second layered extrudate, and provide a layer thickness gradient. Optionally, one or more skin layers 111 can be applied to the outer layers of the second layered extrudate by conducting a third mixture of polymer and diluent 108 (for skin layers) to a skin layer feedblock 110. The skin layers can be produced from the same polymers and diluents used to produce the first and second mixtures, e.g., PE1 and 2, and PP1, though this is not required.

Additional layer multiplication steps (not shown) can be conducted, if desired, to increase the number of layers in the second layered extrudate. The additional layer multiplication steps can be conducted at any point in the process after the first layer multiplication step (e.g., before or after the molding of step 4), as long as there is sufficient diluent (generally at least 10 wt. % based on the weight of the extrudate) to compatibilize the first and second polymers.

Since the first and second polymer are both compatible or miscible with the diluent(s), interdiffusuion occurs during layer multiplication thereby forming a new blend region each time a planar surface of the first portion of the first or second layered extrudate is layered on the a planar surface of the second portion. A blend region is formed from the polymer and diluent in the layers adjacent to (and in face-to-face contact with) the blend region. The thickness and the relative amounts of first and second polymers (and the gradients thereof in the thickness direction) in the blend regions largely depends on the layer contact times, the polymer species selected for the first and second polymer, the diluent, and the extrudate temperature during layer multiplication and molding.

For a first layered extrudate having two layers and an interfacial layer situated therebetween, layer multiplication results in a total of 2⁽ⁿ⁺²⁾−1 distinct regions (layers plus blend regions) in the second layered extrudate, where “n” is an integer ≧1 representing the number of layer multiplications. This is the case even when the first and second polymers would be immiscible (Flory parameter χ≧0; e.g., polyethylene and polypropylene) or poorly compatible in the absence of the diluent. For example, the boundary between layers of polyethylene and isotactic polypropylene has a thickness of approximately 4 nm in blends and co-extruded films of these polymers. Conventional layer multiplication processes using immiscible polymers and without compatible diluent produce 2ⁿ⁺¹ distinct regions. Films produced by such conventional processes have no blend regions (i.e., no layer-layer boundary has a thickness ≧25 nm).

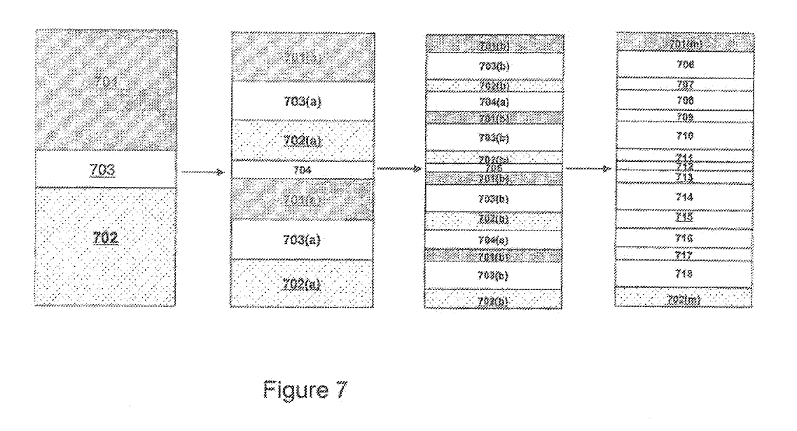

In an embodiment, the microporous polymeric membrane is an eight-layer membrane having 15 compositional regions (eight layers plus seven blend regions). Initial extrusion (or, e.g., casting) of the first and second mixtures produces a first extrudate having two layers and one blend region as shown in FIG. 7, where layer 701 is produced from the first mixture and layer 702 is produced from the second mixture. Layer 703 results from the diffusion of the first and second mixtures during the extrusion process. A first layer multiplication results in a seven-layer membrane as shown in FIG. 7, where layers 701(a) are produced from the first mixture and layers 702(a) are produced from the second mixture. Blend regions 703(a) continue to absorb portions of the adjacent layers 701(a) and 702(a) and new blend region 704 forms the interface where the stacks meet. A second layer multiplication results in a fifteen-layer extrudate where the layers 701(b) are produced from the first mixture and layers 702(b) are third generation layers produced from the second mixture. Third generation blend regions 703(b) and second generation blend regions 704(a) continue to grow and the blend region 705 is formed. Because the inner layers 701(a-b) and 702(a-b) experience diffusion from both surfaces, they are consumed before the outer layers 701(a-b) and 702(a-b), as shown in FIG. 7, where layers 706-718 are blend regions and layers 701(m) and 702(m) comprise residual layers of the first and second polymer mixtures, respectively. Further layer multiplication under diffusion conditions produces an extrudate where the external layers, e.g., external layers 701(a,b,m) and 702(a,b,m), are also consumed and converted to blend regions. Additional layer multiplications can be conducted, if desired, either alone of in combination with the molding of step (4). Optionally, the membrane is a symmetric membrane, e.g., one having a symmetry plane. In an embodiment where the membrane is a symmetric eight-layer membrane, the symmetry plane bisects the fourth blend region, with 50 wt. % of the fourth blend region located on the side of the fourth blend region facing the first outer layer and 50 wt. % of the fourth blend region located on the side of the fourth blend region facing the second outer layer. Optionally, one or more additional layers (and blend regions) can be located between the first and/or second outer layer and the planar surface of the membrane.

In this embodiment, the number of layers in the extrudate following n layer multiplications is equal to 2ⁿ⁺¹. The number of blend regions in the extrudate is equal to 2ⁿ⁺¹−1. The total number of distinct regions in the extrudate (layers plus blend regions) is equal to 2ⁿ⁺²−1, even when the first and second polymers are immiscible polymers.

The thickness of a blend region of the extrudate depends on the inter-layer contact time “t”. Consider a multilayer structure of alternating layers of first and second polymer. When the first and second polymers are brought together to form layers having thicknesses, L1 and L2 respectively, at time t=0, a sharp interface is formed between L1 and L2. At t>0, L1 containing the first mixture and L2 containing the second mixture inter-diffuse into each other, and their interface thus grows into blend region having a thickness T. The thickness T is a function of contact time and diffusion coefficient, and can be estimated using a simplified one-dimensional diffusion model for blend regions formed between layers containing the first mixture and layers containing the second mixture (e.g., between L1 and L2), assuming the layer thickness is much thicker than the blend region. A parameter (j) is defined as the volume concentration of the first mixture in the blend region, with (j) being in the range of 0 (L2) to 1 in (L1). In other words, φ=1 indicates the presence of a homogeneous first mixture and φ=0 indicates a homogeneous second mixture. The thickness of the blend regions “T” is defined by the equation

T=x|_{φ=0.9}−x|_{φ=0.1}

Assuming a constant diffusion coefficient D for the first and second mixture, then the diffusion equation can be used to determine the value of φ as a function of thickness (“x”) in the blend region, given the initial conditions (“I.C.” that φ is zero at t=0 in L2 and φ=1 at t=0 in L1. The spatial boundary conditions are φ(−∞,t)=0; and φ(+∞,t)=1.

$$\{ \frac{\partial φ ( x , t )}{\partial t} = D \frac{{\partial }^{2} φ ( x , t )}{\partial {x}^{2}} \\ I . C . φ ( x , t = 0 ) = 1 , x > 0 , φ ( x , t = 0 ) = 0 , x < 0$$

The analytical solution for φ L1:

$$φ ( x , t ) = \frac{1}{2} [ 1 + erf ( \frac{x}{\sqrt{4 Dt}} ) ]$$

The interfacial thicknesses continue to increase according to the equation for φ so long as there is compatible solvent in the extrudate. The diffusion constant D can be determined by conventional methods. The diffusion of the first polymer into the second region is believed to be driven by a concentration gradient, since the first polymer is a different polymer or mixture of polymers from the second polymer. For example, when a compatible solvent such as liquid paraffin is present, the value of D at the layer multiplication temperature for mixtures of common polyolefins is generally in the range of 10⁻¹¹ m²/sec to 10⁻¹⁵ m²/sec. For a D of 1.3×10⁻¹³ m²/sec for both polyethylene and polypropylene, for example when L1 contains polyethylene and L2 contains polypropylene and the diluent is liquid paraffin, a contact time of 10 seconds results in an blend region having a thickness T=4.5 μm. The thickness of a blend region of the extrudate is generally ≧0.3 μm, e.g., in the range of 0.5 μm to 100 μm or 0.7 μm to 10 μm.

When there is no compatibilizing diluent (as in conventional layer multiplication) the immiscibility of polyethylene and polypropylene would lead to the formation of sharp inter-layer boundaries having no little or no inter-diffusion (less than 2*Rg). In this case (the conventional case), the boundary between the layers, should they exist at all, would have constant, or limiting, thicknesses in the range of 10 Å to 200 Å.

### 4. Molding the Second Layered Extrudate

The second layered extrudate can be molded to reduce its thickness. Optionally, the second layered extrudate's layered structure, i.e., layers substantially parallel (e.g., within about 1°) to each other and the planar face of the extrudate, is preserved during molding. The amount of thickness reduction is not critical, and can be in the range, e.g., of from 125% to about 75%, e.g., 105% to 95% of the thickness of the first layered extrudate. In an embodiment, the molding reduces the thickness of the second layered extrudate until it is approximately equal to thickness of the first layered extrudate. Reducing the thickness of the second layered extrudate is generally conducted without a loss in weight per unit length of greater than about 10% based on the weight of the second layered extrudate; accordingly, the molding generally results in a proportionate increase in the second layered extrudate's width (measured in TD). As an example, the molding can be accomplished using a die or dies 112. The molding can be conducted while exposing the extrudate to a temperature (the “molding temperature”) ≧Tm of the polymer in the extrudate (first or second polymer) having the highest melting point. In an embodiment, the molding temperature is in the range of Tm+10° C. to Tm+140° C. In an embodiment, the extrudate is exposed to a temperature that is the same as (+/−5° C.) as the extrusion temperature. In another embodiment, the second layered extrudate (or third, fourth, etc. layered extrudate) is subjected to additional layer multiplications before molding.

In an embodiment where a skin layer is applied during layer multiplication, it is desirable in most cases to have the skin layers flowing onto the upper and/or lower surfaces of the film as it is conducted through the skin layer feedblock 110 and die(s) 112. When no skin layer is applied, the outer layers of the extrudate become the skin layers. An extrudate leaving the die(s) is typically in molten form.

Conducting the second layered extrudate through a die is believed to apply sufficient compressive shear to produce a polymeric fibrous morphology in the layers of the second layered extrudate, i.e., a morphology different than the homogeneous morphology of the first extrudate. The fibrous structure is desirable, and is produced in conventional “wet” processes for producing microporous films by stretching the extrudate, e.g., in a tenter machine. Since the molding of the first extrudate creates the desirable fibrous structure, the molding obviates at least a portion (if not all) of the stretching that would otherwise be needed in the conventional wet process.

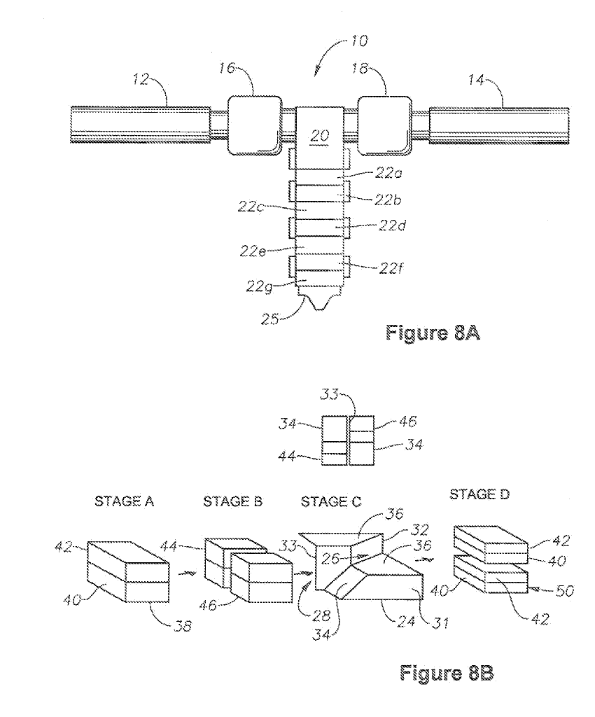

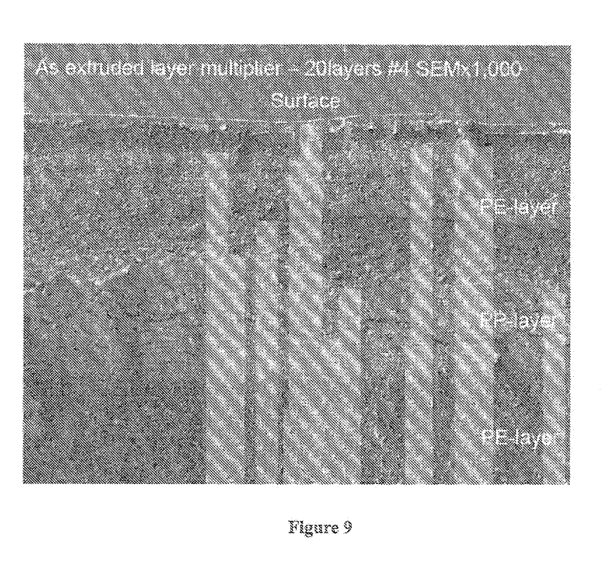

An alternative embodiment for producing the liquid-permeable, microlayer membrane also begins with extruding mixtures comprising the first and second polymer to produce a multi-layer extrudate, as in the description of the first embodiment. FIG. 8A illustrates a coextrusion apparatus 10 for forming the microlayer membrane according to the second embodiment. The apparatus comprises a pair of opposed screw extruders 12 and 14 connected through respective metering pumps 16 and 18 to a coextrusion block 20. A plurality of multiplying elements 22a-g extend in series from the coextrusion block, and are optionally oriented approximately perpendicular to the screw extruders 12 and 14. Each of the multiplying elements comprise a die element 24 disposed in the polymer-diluent mixture passageway of the coextrusion device. The last multiplying element 22g is attached to a discharge nozzle 25 through which a layer-multiplied extrudate extrudes.

A schematic diagram of the layer-multiplication process carried out by the apparatus 10 is illustrated in FIG. 8B, which also illustrates the structure of the die element 24 disposed in each of the multiplying elements 22a-g. Each die element 24 divides the polymer-diluent mixture passage into two passages 26 and 28 with adjacent blocks 31 and 32 separated by a dividing wall 33. Each of the blocks 31 and 32 includes a ramp 34 and an expansion platform 36. The ramps 34 of the respective die element blocks 31 and 32 slope from opposite sides of the melt flow passage toward the center of the melt flow passage. The expansion platforms 36 extend from the ramps 34 on top of one another.

In this alternative embodiment, the liquid-permeable, microlayer membrane is produced using apparatus 10 by extruding a first mixture comprising the first polymer and first diluent and a second mixture comprising the second polymer and the second diluent. The first mixture is extruded through the first single screw extruder 12 into the coextrusion block 20, and the second mixture is extruded through the second single screw extruder 14 into the same coextrusion block 20. In the coextrusion block 20, a two-layer extrudate 38, such as that illustrated at stage A in FIG. 8B is formed with the layer 42 comprising the first mixture on top of the layer 40 comprising the second mixture. The layered extrudate is then extruded through the series of multiplying elements 22a-g to form a 256-microlayer extrudate with microlayers comprising the first mixture alternating with microlayers comprising the second mixture, with blend regions situated between the alternating microlayers. As the layered extrudate 38 is extruded through the first multiplying element 22a, the dividing wall 33 of the die element 24 separates the layered extrudate 38 into two sections (optionally in half) 44 and 46 each having a layer comprising the first polymer 40 and a layer comprising the second polymer 42, as shown in FIG. 8B, stage B. As the layered extrudate 38 is divided, each of the halves 44 and 46 are conducted along the respective ramps 34 and out of the die element 24 along the respective expansion platforms 36. This reconfiguration (a manipulation to reduce extrudate thickness) of the layered extrudate is illustrated at stage C in FIG. 8B. When the divided sections of layered extrudate 38 exit from the die element 24, the expansion platform 36 positions the divided sections 44 and 46 on top of one another to form an extrudate 50 having a substantially parallel stacking arrangement. This process is repeated as the layered extrudate proceeds through each of the multiplying elements 22b-g. When the extrudate is discharged through the discharge nozzle 25, the extrudate comprises, e.g., 256 microlayers.

The second embodiment thus differs from the first embodiment in that the layered extrudate sections are molded (extrudate thickness is decreased and area is increased) before the sections are stacked to form a layered extrudate having a greater number of layers. The process parameters in the second embodiment, e.g., selection and amounts of polymer and diluent, molding parameters, process temperatures, etc., can be the same as those described in the analogous part of the first embodiment. The microlayer apparatus of the second embodiment is described in more detail in an article by Mueller et al., entitled Novel Structures By Microlayer Extrusion—Talc-Filled PP, PC/SAN, and HDPE-LLDPE. A similar process is described in U.S. Pat. Nos. 3,576,707; 3,051,453; and 6,261,674, the disclosures of which are incorporated herein by reference in their entirety.

Optional cooling and stretching steps can be used in the first and second embodiment. For example, extrudate can be cooled following molding. Cooling rate and cooling temperature are not particularly critical. For example, the layered extrudate can be cooled at a cooling rate of at least about 50° C./minute until its temperature (the cooling temperature) is approximately equal to the extrudate's gelation temperature (or lower). Process conditions for cooling can be the same as those disclosed in PCT Pat. Pub. WO 2008/016174, for example. The layered extrudate can be stretched, if desired. Stretching (also called “orientation”), when used, can be conducted before and/or after extrudate molding. Stretching can be used even when a fibrous structure is produced in the layered extrudate during the molding. When stretching is used, it is believed that the presence of the first and second diluents in the extrudate results in a relatively uniform stretching magnification. Exposing the extrudate to an elevated temperature (the stretching temperature), especially at the start of stretching or in a relatively early stage of stretching (for example, before 50% of the stretching has been completed), is also believed to aid the uniformity of stretching. In an embodiment, the stretching temperature is ≦ the Tm of the polymer in the extrudate having the lowest (coolest) melting peak. Neither the choice of stretching method nor the degree of stretching magnification is particularly critical as stretching can be symmetric or asymmetric. The order of stretching can be sequential or simultaneous. Stretching conditions can be the same as those disclosed in PCT Pat. Pub. WO 2008/016174, for example.

The relative thickness of the first and second layers of the microlayer extrudate made by the foregoing embodiments can be controlled, e.g., by one or more of (i) regulating the relative feed ratio of the first and second mixtures into the extruders, (ii) regulating the relative amount of polymer and diluent in the first and second mixtures, etc. In addition, one or more extruders can be added to the apparatus to increase the number of different polymers in the microlayer membrane. For example, a third extruder can be added to add a tie layer to the membrane.

### 5. Removal of the Diluents

In an embodiment, at least a portion of the first and second diluents (e.g., 10 membrane-forming solvents) are removed (or displaced) from the molded extrudate in order to form a multi-layer microporous membrane. A displacing (or “washing”) solvent can be used to remove (wash away, or displace) the first and second diluents. Process conditions for removing first and second diluents can be the same as those disclosed in PCT Publication WO 2008/016174, for example. Removing the diluent (and cooling the extrudate as described below) reduces the value of the diffusion coefficient D, resulting in little or no further increase in the thicknesses of the blend regions.

### 6. Optional Cooling

### Formation of a Cooled Extrudate, e.g., a Multi-Layer, Gel-Like Sheet

The extrudate can be cooled if desired following molding. Cooling rate and 20 cooling temperature are not particularly critical. For example, the second layered extrudate can be cooled at a cooling rate of at least about 50° C./minute until its temperature (the cooling temperature) is approximately equal to the extrudate's gelation temperature (or lower). Process conditions for cooling can be the same as those disclosed in PCT Publication WO 2008/016174, for example.

### 7. Optional First Stretching

Prior to the step for removing the diluent(s) from the extrudate (e.g., at one or more points prior to step 5), the extrudate can be stretched in order to obtain a stretched second extrudate. Stretching, when used, can be conducted before and/or after the molding. Unlike the conventional “wet” process, stretching is optional since a fibrous structure is produced in the extrudate during the molding. When stretching is used, it is believed that the presence of the first and second diluents in the extrudate results in a relatively uniform stretching magnification. Heating the extrudate, especially at the start of stretching or in a relatively early stage of stretching (for example, before 50% of the stretching has been completed) is also believed to aid the uniformity of stretching.

Neither the choice of stretching method nor the degree of stretching magnification is particularly critical stretching can be symmetric or asymmetric, and the order of stretching can be sequential or simultaneous. Stretching conditions can be the same as those disclosed in PCT Publication WO 2008/016174, for example.

### 8. Optional Drying of the Membrane

In an embodiment, at least a portion of any remaining volatile species is removed from the membrane (membrane “drying”) following diluent removal. For example, the membrane can be dried by removing at least a portion of the washing solvent. Any method capable of removing the washing solvent can be used, including conventional methods such as heat-drying, wind-drying (moving air), etc. Process conditions for removing volatile species such as washing solvent can be the same as those disclosed in PCT Publication WO 2008/016174, for example.

### 9. Optional Stretching of the Multi-Layer Membrane

In an embodiment, the multi-layer microporous membrane can be stretched at any time after step (5). The stretching method selected is not critical, and conventional stretching methods can be used such as by a tenter method, etc. Optionally, the membrane is heated during stretching. The stretching can be, e.g., monoaxial or biaxial. When biaxial stretching is used, the stretching can be conducted simultaneously in, e.g., the MD and TD directions, or, alternatively, the multi-layer microporous polyolefin membrane can be stretched sequentially, for example, first in MD and then in TD. In an embodiment, simultaneous biaxial stretching is used. When the multi-layer extrudate has been stretched as described in step (7), the stretching of the dry multi-layer microporous polyolefin membrane in step (9) can be called dry-stretching, re-stretching, or dry-orientation to distinguish membrane stretching from extrudate stretching.

The temperature of the multi-layer microporous membrane during stretching (the “dry stretching temperature”) is not critical. In an embodiment, the dry stretching temperature is approximately equal to Tm or lower, for example in the range of from about the crystal dispersion temperature (“Ted”) to about Tm, where Tm is the melting point of the polymer in the membrane having the highest melting point. When the dry stretching temperature is higher than Tm, it can be more difficult to produce a multi-layer microporous polyolefin membrane having a relatively high compression resistance with relatively uniform air permeability characteristics, particularly in the transverse direction when the dry multi-layer microporous polyolefin membrane is stretched transversely. When the stretching temperature is lower than Ted, it can be more difficult to sufficiently soften the first and second polymers, which can lead to tearing during stretching, and a lack of uniform stretching. In an embodiment, the dry stretching temperature ranges from about 90° C. to about 135° C., for example from about 95° C. to about 130° C.

When dry-stretching is used, the stretching magnification is not critical. For example, the stretching magnification of the multi-layer microporous membrane can range from about 1.1 fold to about 1.8 fold in at least one planar (e.g., lateral) direction. Thus, in the case of monoaxial stretching, the stretching magnification can range from about 1.1 fold to about 1.8 fold in the longitudinal direction (i.e., the “machine direction”) or the transverse direction, depending on whether the membrane is stretched longitudinally or transversely. Monoaxial stretching can also be accomplished along a planar axis between the longitudinal and transverse directions. It is believed that dry-stretching to a magnification larger than 1.8 fold results in a degradation in the membrane's heat shrinkage ratio in MD or TD, or both MD and TD.

In an embodiment, biaxial stretching is used (i.e., stretching along two planar 15 axes) with a stretching magnification of about 1.1 fold to about 1.8 fold along both stretching axes, e.g., along both the longitudinal and transverse directions. The stretching magnification in the longitudinal direction need not be the same as the stretching magnification in the transverse direction. In other words, in biaxial stretching, the stretching magnifications can be selected independently. In an embodiment, the dry-stretching magnification is the same in both stretching directions.

In an embodiment, dry stretching involves stretching the membrane to an intermediate size as described above (generally to a magnification that is from about 1.1 fold to about 1.8 fold larger than the membrane's size in the stretching direction at the start of dry-stretching) and then relaxing (e.g., shrinking) the membrane in the direction of stretching to achieve a final membrane size in the stretching direction that is smaller than the intermediate size but larger than the size of the membrane in the stretching direction at the start of dry stretching. Generally, during relaxation the film is exposed to the same temperature as is the case during the dry-stretching to the intermediate size. In another embodiment, the membrane is stretched to an intermediate size that is larger than about 1.8 fold the size of the membrane at the start of dry-stretching, as long as the final size of the membrane (e.g., the width measured along TD when the stretching is along TD) in either or both planar directions (MD and/or TD) is in the range of 1.1 to 1.8 fold the size of the film at the start of the dry-stretching step. As a non-limiting example, the membrane is stretched to an initial magnification of about 1.4 to 1.7 fold in MD and/or TD to an intermediate size, and then relaxed to a final size at a magnification of about 1.2 to 1.4 fold, the magnifications being based on the size of the film in the direction of stretching at the start of the dry-stretching step. In another embodiment, the membrane is dry-stretched in TD at an initial magnification to provide a membrane having an intermediate size in TD (an intermediate width) and then relaxed to a final size in TD that is in the range of about 1% to about 30%, for example from about 5% to about 20%, of the intermediate size in TD. This relaxation can be accomplished, for examples, by moving the tenter clips gripping the edges of the membrane toward the center line of the machine direction.

The stretching rate is preferably 3%/second or more in a stretching direction. In the case of monoaxial stretching, stretching rate is 3%/second or more in a longitudinal or transverse direction. In the case of biaxial stretching, stretching rate is 3%/second or more in both longitudinal and transverse directions. It is observed that a stretching rate of less than 3%/second decreases the membrane's permeability, and provides the membrane with large variation in measured properties across the membrane along TD (particularly air permeability). The stretching rate is preferably 5%/second or more, more preferably 10%/second or more. Though not particularly critical, the upper limit of the stretching rate can be 50%/second or more provided the membrane is not ruptured during stretching.

### Additional Steps

Further optional steps such as (10) heat treatment, (11) cross-linking, and (12) hydrophilizing treatment can be conducted, if desired, under the conditions disclosed in PCT Publication WO 2008/016174, for example.

### Properties of the Multi-Layer Microporous Membrane

In an embodiment, the multi-layer microporous membrane has a thickness ≧1 μm, e.g., a thickness in the range of from about 3 μm to about 250 μm, for example from about 5 μm to about 50 μm. Thickness meters such as the Litematic available from Mitsutoyo Corporation are suitable for measuring membrane thickness. Non-contact thickness measurement methods are also suitable, e.g. optical thickness measurement methods. In an embodiment, the sum of the number of distinct compositional regions in the membrane (layers containing the first polymer, layers containing the second polymer, and blend regions containing both the first and second polymer) is an odd number equal to 2ⁿ⁺²−1, where “n” is an integer≧1 which can be equal to the number of layer multiplications. Λ “beta factor” (“β”) can be used to describe the multi-layer microporous membrane, where β is equal to the thickness of the thickest blend region divided by the thickness of the thinnest blend region. Generally, for the membranes of the invention, β>1, e.g., in the range of about 1.05 to 10, or 1.2 to 5, or 1.5 to 4.

Optionally, the membrane can have one or more of the following properties:

### A. Porosity≧20%

The membrane's porosity is measured conventionally by comparing the membrane's actual weight to the weight of an equivalent non-porous membrane of 100% polyethylene (equivalent in the sense of having the same length, width, and thickness). Porosity is then determined using the formula: Porosity %=100×(w2−w1)/w2, “w1” is the actual weight of the microporous membrane and “w2” is the weight of an equivalent non-porous membrane (of the same polymers) having the same size and thickness. In an embodiment, the membrane's porosity is in the range of 25% to 85%.

B. Normalized Air Permeability≧20 Seconds/100 cm³/20 μm (Normalized to Equivalent Value at 20 μm Membrane Thickness)

In an embodiment, the normalized air permeability of the multi-layer, microporous polyolefin membrane (as measured according to JIS P8117) is represented as Gurley Value (units of seconds/100 cm³) normalized to an equivalent Gurley Value at a membrane thickness of/20 μm and is therefore expressed in units of seconds/100 cm³/20 μm. The membrane's normalized air permeability is in the range of from about 20 seconds/100 cm³/20 μm to about 500 seconds/100 cm³/20 μm, or from about 100 seconds/100 cm³/20 μm to about 400 seconds/100 cm³/20 μm. The measured air permeability P₁ of a microporous membrane having an actual average thickness T_{A} according to JIS P8117 can be normalized to an air permeability P₂ at a thickness of 20 μm using the equation P₂=(P₁×20 μm)/T_{A}.

### C. Normalized Pin Puncture Strength≧2,000 mN (Normalized to Equivalent Value at 20 μm Membrane Thickness)

Pin puncture strength is defined as the maximum load measured (in grams Force or “gF”) when a microporous membrane having an actual average thickness of TA is pricked with a needle of 1 mm in diameter with a spherical end surface (radius R of curvature: 0.5 mm) at a speed of 2 mm/second. The membrane's measured pin puncture strength (“S”) is normalized to a value at a membrane thickness of 20 μm using the equation S₂=20 μm*(S₁)/T_{A}, where S₁ is the measured pin puncture strength, S₂ is the normalized pin puncture strength, and T_{A} is the actual average thickness of the membrane.

In an embodiment, the normalized pin puncture strength of the membrane is ≧3,000 mN/20 μm, e.g., ≧5000 mN/20 μm, such as in the range of 3,000 mN/20 μm to 8,000 mN/20 μm.

### D. Tensile Strength≧1200 Kg/cm

Tensile strength is measured in MD and TD according to ASTM D-882A. In an embodiment, the membrane's MD tensile strength is in the range of 1000 Kg/cm² to 2,000 Kg/cm², and TD tensile strength is in the range of 1200 Kg/cm² to 2300 Kg/cm².

### E. Shutdown Temperature≦140° C.

The shut down temperature of the microporous membrane is measured by a thermomechanical analyzer (TMA/SS6000 available from Seiko Instruments, Inc.) as follows: A rectangular sample of 3 mm×50 mm is cut out of the microporous membrane such that the long axis of the sample is aligned with the transverse direction of the microporous membrane and the short axis is aligned with the machine direction. The sample is set in the thermomechanical analyzer at a chuck distance of 10 mm, i.e., the distance from the upper chuck to the lower chuck is 10 mm. The lower chuck is fixed and a load of 19.6 mN applied to the sample at the upper chuck. The chucks and sample are enclosed in a tube which can be heated. Starting at 30° C., the temperature inside the tube is elevated at a rate of 5° C./minute, and sample length change under the 19.6 mN load is measured at intervals of 0.5 second and recorded as temperature is increased. The temperature is increased to 200° C. “Shut down temperature” is defined as the temperature of the inflection point observed at approximately the melting point of the polymer having the lowest melting point among the polymers used to produce the membrane. In an embodiment, the shutdown temperature is 140° C. or less, e.g., in the range of 128° C. to 133° C.

### F. Meltdown Temperature≧145 ° C.

Melt down temperature is measured by the following procedure: A rectangular sample of 3 mm×50 mm is cut out of the microporous membrane such that the long axis of the sample is aligned with the transverse direction of the microporous membrane as it is produced in the process and the short axis is aligned with the machine direction. The sample is set in the thermomechanical analyzer (TMA/SS6000 available from Seiko Instruments, Inc.) at a chuck distance of 10 mm, i.e., the distance from the upper chuck to the lower chuck is 10 mm. The lower chuck is fixed and a load of 19.6 mN applied to the sample at the upper chuck. The chucks and sample are enclosed in a tube which can be heated. Starting at 30° C., the temperature inside the tube is elevated at a rate of 5° C./minute, and sample length change under the 19.6 mN load is measured at intervals of 0.5 second and recorded as temperature is increased. The temperature is increased to 200° C. The melt down temperature of the sample is defined as the temperature at which the sample breaks, generally at a temperature in the range of about 145° C. to about 200° C. In an embodiment, the meltdown temperature is in the range of from 145° C. to 195° C., e.g., 150° C. to about 190° C.

### [5] Battery Separator

In an embodiment, the microporous membrane of any of the preceding embodiments is useful for separating electrodes in energy storage and conversion devices such as lithium ion batteries.

### [6] Battery

The microporous membranes of the invention are useful as battery separators in e.g., lithium ion primary and secondary batteries. Such batteries are described in PCT publication WO 2008/016174.

The battery is useful for powering one or more electrical or electronic components, Such components include passive components such as resistors, capacitors, inductors, including, e.g., transformers; electromotive devices such as electric motors and electric generators, and electronic devices such as diodes, transistors, and integrated circuits. The components can be connected to the battery in series and/or parallel electrical circuits to form a battery system. The circuits can be connected to the battery directly or indirectly. For example, electricity flowing from the battery can be converted electrochemically (e.g., by a second battery or fuel cell) and/or electromechanically (e.g., by an electric motor operating an electric generator) before the electricity is dissipated or stored in a one or more of the components. The battery system can be used as a power source for powering relatively high power devices such as electric motors in power tools and electric or hybrid electric vehicles.

Particular embodiments will now be described with respect to the following separately numbered paragraphs.
1. In particular embodiments the microporous membrane includes
   a) a first blend region comprising a first polymer and a second polymer and having a first concentration profile of the first polymer, or representation thereof, that varies in the thickness direction of the first blend region; and
   b) a second blend region in surface contact with the first blend region and comprising the first polymer and the second polymer and having a second concentration profile of the first polymer, or representation thereof the second concentration varying in the thickness direction of the second blend region.
2. The membrane of paragraph 1 further comprising a first microporous microlayer (Ml) having a thickness ≦1.0 μm, and a second microporous microlayer having a thickness ≦1.0 μm, wherein the first and second blend regions are located between the first and second microporous layers.
3. The membrane of paragraph 2, wherein the first microporous microlayer comprises the first polymer and the second microporous microlayer comprises the first polymer.
4. The membrane of paragraph 2, wherein the first microporous microlayer comprises the first polymer and the second microporous microlayer comprises the second polymer.
5. The membrane of any of paragraphs 1 to 4, wherein the membrane is liquid-permeable.
6. The membrane of any of paragraphs 1 to 5, wherein the first polymer is incompatible with the second polymer.
7. The membrane of any of paragraphs 1 to 6, wherein the first polymer comprises polyethylene and the second polymer comprises polypropylene.
8. The membrane of paragraph 7, wherein the first polymer is selected from at least one of a) a polyethylene having an Mw<1.0×10⁶ and a terminal vinyl content<0.20 per 10,000 carbon atoms; b) a polyethylene having a molecular weight≧1.0×10⁶; and c) a polyethylene homopolymer or copolymer having a molecular weight ranging from 5×10³ to 2.0×10⁵ and a melting point ranging from 115.0° C. to 130.0° C.; and the second polymer is selected from at least one of: a) a polypropylene having an Mw≧1.0×10⁶ and a heat of fusion of ≧90 J/g; and b) a polypropylene homopolymer or copolymer having a molecular weight ranging from 5×10³ to 2.0×10⁵ and a melting point ranging from 115.0° C. to 130.0° C.
9. The membrane of any of paragraphs 1 to 8, wherein the thickness of the first blend region is greater than the individual thicknesses of the first and second microporous microlayers.
10. The membrane of any of paragraphs 1 to 9, wherein the first concentration profile has a negative slope and the second concentration profile has a positive slope.
11. The membrane of any of paragraphs 1 to 10, further comprising at least a third blend region having a third concentration profile of the first polymer that varies in the thickness direction of the third blend region and located between the first and second microporous microlayers.
12. The membrane of paragraph 11, wherein the second and third blend regions each have a thickness greater than a thickness of the first blend region and the third blend region is in surface contact with the first blend region.
13. The membrane of paragraph 11, wherein the second and third blend regions each have a thickness less than a thickness of the first blend region and the third blend region is in surface contact with the first blend region.
14. The membrane of any of paragraphs 1 to 13, further comprising a plurality of additional blend regions comprising the first polymer and the second polymer and located between the first and second microporous microlayers.
15. The membrane of any of paragraphs 1 to 14, wherein the membrane comprises from 12 to 4,000 layers.
16. The membrane of any of paragraphs 1 to 15, wherein the membrane has a normalized air permeability in the range of 50 seconds/100 cm³ to 1,000 seconds/100 cm³.
17. The membrane of any of paragraphs 1 to 16, wherein the membrane has a normalized pin puncture strength in the range of 200 gF to 1,000 gF.
18. The membrane of claim any of paragraphs 1 to 17, wherein the membrane has 105° C. heat shrinkage in at least one planar direction ≦10%.
19. The membrane of any of paragraphs 1 to 18, wherein the membrane has a thickness in the range of 3 μm to 100 μm.
20. The membrane of any of paragraphs 1 to 19, wherein the first and second blend regions each have a thickness in the range of 25 nm to 0.5 μm.
21. A microporous membrane comprising a first polymer and a second polymer, wherein the composition of the first polymer varies continuously in the thickness direction from a first surface of the film to a second surface of the film.
22. The membrane of paragraph 21, wherein the first and second polymers are selected at least one of: a) a polyethylene having an Mw<1.0×10⁶ and a terminal vinyl content<0.20 per 10,000 carbon atoms; b) a polyethylene having a molecular weight≧1.0×10⁶; c) a polyethylene homopolymer or copolymer having a molecular weight ranging from 5×10 to 2.0×10⁵ and a melting point ranging from 115.0° C. to 130.0° C.; d) a polypropylene having an Mw≧1.0×10⁶ and a heat of fusion of ≧90 J/g; and e) a polypropylene homopolymer or copolymer having a molecular weight ranging from 5×10³ to 2.0×10⁵ and a melting point ranging from 115.0° C. to 130.0° C.
23. A microporous membrane having a thickness of ≦25 μm, comprising at least 8 layers, each layer having a thickness of ≦3.3 μm; each of the layers comprising a first polymer and a second polymer and having a concentration profile of the first polymer that varies in the thickness direction of the respective layer, with the proviso that the skin layers of the membrane may independently consist essentially of either the first or second polymer.
24. The membrane of paragraph 23, wherein the first and second polymers are selected at least one of: a) a polyethylene having a Mw<1.0×10⁶ and a terminal vinyl content<0.20 per 10,000 carbon atoms; b) a polyethylene having a molecular weight≧1.0×10⁶; c) a polyethylene or polypropylene homopolymer or copolymer having a molecular weight ranging from 5×10³ to 2.0×10⁵ and a melting point ranging from 115.0° C. to 130.0° C.; d) a polypropylene having an Mw≧1.0×10⁶ and a heat of fusion of >90 J/g; and e) a polypropylene homopolymer or copolymer having a molecular weight ranging from 5×10³ to 2.0×10⁵ and a melting point ranging from 115.0° C. to 130.0° C.
25. A microporous membrane having first and third layers comprising a first polymer; second and fourth layers comprising a second polymer; and first, second, and third blend regions each comprising the first and second polymer; the first blend region being located between the first and second layers, in face-to-face contact therewith, and having a thickness T1; the second blend region being located between the second and third layers, in face-to-face contact therewith, having a thickness T2; and the third blend region being located between the third and fourth layers, in face-to-face contact therewith, and having a thickness T3; T2 satisfying the relationships [(T1−T2)/T1]≧0.05 and [(T3−T2)/T3]≧0.05; and T1, T2, and T3 each being in the range of 25 nm to 5 μm.

26. A multi-layer microporous polymeric membrane having a β≧1.05.
27. The multi-layer microporous polymeric membrane of claim 23, wherein β is in the range of 1.2 to 5.
28. A multi-layer microporous polymeric membrane comprising a first blend region having a thickness T1, a the third blend region having a thickness T3, and a second blend region located between the first and third blend regions and having a thickness T2; wherein [(T1−T2)/T1]≧0.05 and [(T3−T2)/T3]≧0.05.and having a porosity≧20%, a normalized air permeability≧20 seconds/100 cm³/20 μm/a shut down temperature≦140° C., and a melt down temperature≧145° C.
29. A method for making a microporous membrane comprising:
   a) manipulating a first layered article comprising first and second layers, wherein the first layer comprises a first diluent and a first polymer, wherein the second layer comprises a second diluent miscible with the first diluent and a second polymer different from the first polymer, to produce a second layered article having an increased number of layers including first and second adjacent blend regions that include the first polymer composition and the second polymer composition; and
   b) removing at least a portion of the first and second diluents from the second article to produce the microporous membrane.
30. The method of paragraph 29, wherein manipulating the first layered article includes reducing the thickness and increasing the width of at least a section of the first article before producing the second article.
31. The method of paragraph 29, wherein manipulating the first layered article includes reducing the thickness and increasing the width of at least a section of the second article.
32. The method of paragraph 29, further comprising stretching the second article in at least one planar direction before removing at least a portion of the diluents.
33. The method of paragraph 29, further comprising stretching the second article in at least one planar direction after removing at least a portion of the diluents.
34. The method of paragraph 29, further comprising cooling the second article before removing at least a portion of the diluents.
35. The method of paragraph 29, further comprising exposing the membrane to an elevated temperature after removing at least a portion of the diluents.
36. The method of paragraph 29, wherein the first and second diluent comprises liquid paraffin.
37. A microporous membrane made according to any of paragraphs 25 to 32.
38. A battery separator comprising the membrane of any of paragraphs 1 to 24.
39. A battery comprising the battery separator of claim 34.
40. A battery comprising an electrolyte, an anode, a cathode, and a polymeric separator situated between the anode and the cathode, wherein the separator comprises a first blend region having a thickness T1, a the third blend region having a thickness T3, and a second blend region located between the first and third blend regions and having a thickness T2; wherein [(T1−T2)/T1]≧0.05 and [(T3−T2)/T3]≧0.05.

The present invention will be explained in more detail referring to Examples below without intention of restricting the scope of the present invention.

### EXAMPLES

The present invention will be explained in more detail referring to examples below without intention of restricting the scope of the present invention.

### Example 1

### (1) Preparation of the First Mixture

A first polymer comprising (a) 18 wt. % of a polyethylene resin (UHMWPE) having an Mw of 2.0×10⁶ and an MWD of 5.1 and (b) 82.0 wt. % of a polyethylene resin (HDPE) having an Mw of 5.6×10⁵, an MWD of 4.1, a Tc of 135° C., and a Ted of 100° C. is prepared by dry-blending, the weight percents being based on the weight of the first polymer.

Twenty-five wt. % of first polymer is charged into an strong-blending double-screw extruder having an inner diameter of 58 mm and L/D of 42 and 75 wt. % of liquid paraffin (50 cSt at 40° C.) is supplied to the double-screw extruder via a side feeder to produce the first mixture, the weight percents being based on the weight of the first mixture. Particular conditions in the first extruder are recorded in Table 2.

### (2) Preparation of the Second Mixture

A second polymer is prepared in the same manner as above except as follows. The second polymer comprises (a) 50.0 wt. % of a polypropylene having an Mw of 1.1×10⁶ (UHWMiPP), an MWD of 5, a Tm of 164° C., and a ΔHm of 114.0 J/g, (b) 1.0 wt. % of a polyethylene resin (UHMWPE) having an Mw of 2.0×10⁶ and an MWD of 5.1 and (c) 49.0 wt. % of a polyethylene resin (HDPE) having an Mw of 5.6×10⁵, an MWD of 4.1, a Tc of 135° C., and a Ted of 100° C. is prepared by dry-blending based on the weight of the second polymer. Thirty-five wt. % of the second polymer is charged into a strong-blending, double-screw extruder having an inner diameter of 58 mm and L/D of 42, and 65 wt. % of the liquid paraffin is supplied to the double-screw extruder via a side feeder to produce a second mixture. Particular conditions in the second extruder are recorded in Table 2.

### (3) Extrusion

The first and second mixtures are combined to produce a two-layer extrudate having a total thickness of 1.0 mm that is then conducted to a sequence of layer-multiplication stages. Each stage, shown schematically in FIG. 8B, layer-multiply the extrudate while exposing the extrudate to a temperature of 220° C.

Accordingly, the first mixture is extruded through the first single screw extruder 812 into the coextrusion block 820, and the second mixtures is extruded through the second single screw extruder 814 into the same coextrusion block 820. In the coextrusion block 820, a two-layer extrudate 838, such as that illustrated at stage A in FIG. 8B, is formed with the layer 842 comprising the first mixture on top of the layer 840 comprising the second mixture. The layered extrudate is then extruded through the series of multiplying elements 822a-g to produce an 80-layer extrudate with layers comprising mixtures of the first and second polymers. The extrudate residence time in each layer-multiplication stage is approximately 2.5 seconds. The microlayer extrudate has a thickness of 1.0 mm and a width of 0.1 m.

During layer multiplication, the first layered extrudate having a thickness of 2 mm is separated into two sections by dividing the first layered extrudate equally along MD, and then the sections are combined to produce a second layered extrudate having a thickness equal of 4 mm. A layer multiplier is used to separate first and second sections of the first extrudate along the machine direction on a line at the midpoint of TD and perpendicular to the planar surface of the extrudate. The layer multiplier redirects and “stacks” the first section atop the second section (planar surface to planar surface) to increase the number of layers and produce the second extrudate. The layer multiplication is conducted while the extrudate is exposed to a temperature of shown in Table 1. The duration of layer multiplication is 2.5 seconds, i.e., a total of 5 seconds from the introduction of the first and second mixtures into the feedblock.

The second extrudate contains four layers and three blend regions as shown in FIG. 2. At the conclusion of the first layer multiplication, the second extrudate has a thickness of 4 mm; a width of 0.02 m; the thickness Li, 12, L3, and L4 of the layers are each 1 mm; the thicknesses I1 and I3 of blend regions 202, 206 have a thickness of 81 μm; while blend region 204 has a thickness I2 of 57 μm; and β=1.42. The extrudate does not have a fibrous structure.

Following the first layer multiplication, the extrudate undergoes a second layer multiplication. The conditions of this layer multiplication step are the same as those of the first layer multiplication. The second layer multiplication concludes 10 seconds after the first and second mixture are introduced into the feedblock. At this point, the extrudate (shown in FIG. 7d has a thickness of 8 mm; a width of 0.01 m; the thickness of the layers are each 1 mm; the blend regions I1 and I7 have a thickness of 115 μm; I2 and I6 have a thickness of 99 μm; I3 and I5 have a thickness of 81 μm; newly created interface I4 has a thickness of 57 μm; and β=2.02. The extrudate does not have a fibrous structure.

The layer multiplication process is continued to produce an 80-layer extrudate with layers comprising mixtures of the first and second polymers. The extrudate residence time in each layer-multiplication stage is approximately 2.5 seconds. The microlayer extrudate has a thickness of 1.0 mm and a width of 0.1 m.

The microlayer extrudate is then cooled while passing through cooling rollers controlled at 20° C., to form a cooled microlayer extrudate, which is simultaneously biaxially stretched at 115° C. to a magnification of 5 fold in both MD and TD by a tenter stretching machine. The stretched extrudate is fixed to an aluminum frame of 20 cm×20 cm, immersed in a bath of methylene chloride controlled at 25° C. to remove liquid paraffin with vibration of 100 rpm for 3 minutes, and dried by air flow at room temperature. The membrane is then heat-set at 115° C. for 10 minutes to produce the finished liquid-permeable, microlayer membrane having a width of 2.5 m and a thickness of 40° μm. The membrane has a β=1.59. Typical membrane properties are shown in Table 2.

### (4) Extrudate Molding

Following the second layer multiplication, the extrudate is molded to reduce the extrudate's thickness to 2 mm and increase the extrudate's width to 0.04 m. The molding temperature is 210° C., and molding is conducted for 2.5 seconds. The second molding concludes 12.5 seconds after the first and second mixtures are introduced into the feedblock. At this point, the extrudate has a thickness of 2 mm; a width 0.04 m; the thickness of the layers L1 through L8 are each 0.25 mm; the blend regions I1 and I7 have a thickness of 32.25 μm; I2 and I6 have a thickness of 28.75 μm; I3 and I5 have a thickness of 24.75 μm; I4 has a thickness of 20.25 μm; and β=1.59. The extrudate has a fibrous structure.

### (5) Diluent Removal, Etc.

Following second molding, the extrudate is cooled while passing through cooling rollers controlled at 20° C., to form a cooled extrudate, which is simultaneously biaxially stretched at 119.3° C. to a magnification of 5 fold in both machine (longitudinal) and transverse directions by a tenter stretching machine to produce a stretched extrudate. The stretched extrudate is fixed to an aluminum frame of 20 cm×20 cm, immersed in a bath of methylene chloride controlled at 25° C. to remove liquid paraffin with vibration of 100 rpm for 3 minutes, and dried by air flow at room temperature. The membrane is then heat-set at 127.3° C. for 10 minutes to produce the finished membrane having a width of lm and a thickness of 80 μm. The heat-set membrane has a β=1.59.

Examples 2-8 were prepared in substantially the same manner except that extrusion conditions summarized in Table 1 were used.

TABLE 1

| Ex. | Extruder 1 (1″) conditions | Extruder 2 (¾″) conditions | Die conditions | Chiller Temp. |
|---|---|---|---|---|
| 2 | Temp: 190° C. | Temp: 190° C. | Temp: 220° C. | — |
| | Pressure: 770 psi | Pressure: 1200 psi | Layer: 80 layers | |
| | Screw rotation: | Screw rotation: 47 rpm | (20 × 2 × 2) | |
| | 20 rpm | Geared pump: 10 rpm | Die lip width: 2″, | |
| | Geared pump: 20 rpm | Material: UHMPE/HDPE | gap: 1 mm | |
| | Material: UHMWiPP | | Output: 17.3-16.9 g/min | |
| 3 | Temp: 185° C. | Temp: 180° C. | Temp: 210° C. | — |
| | Pressure: 1300 psi | Pressure: 400 psi | Layer: 80 layers | |
| | Screw: 20 rpm | Screw: 47 rpm | (20 × 2 × 2) | |
| | Gear pump: 20 rpm | Gear pump: 10 rpm | Die lip width: 2″, | |
| | Material: UHMWiPP | Output: 18.3-18.0 g/min | gap: 1 mm | |
| | | Material: UHMPE/HDPE | Output: 18.3-18.0 g/min | |
| 4 | Temp: 185° C. | Temp: 180° C. | Temp: 200° C. | — |
| | Pressure: 800 psi | Pressure: 700 psi | Layer: 80 layers | |
| | Screw: 20 rpm | Screw: 47 rpm | (20 × 2 × 2) | |
| | Gear pump: 20 rpm | Gear pump: 10 rpm | Die lip width: 2″, | |
| | Material: UHMWiPP | Material: UHMWiPP | gap: 1 mm | |
| | | | Output: 17.3-16.9 g/min | |
| 5 | Temp: 185° C. | Temp: 180° C. | Temp: 180° C. | Temp: |
| | Pressure: 800 psi | Pressure: 1400 psi | Layer: 20 layers | 10° C. |
| | Screw: 36 rpm | Screw: 43 rpm | Die lip width: 2″, | |
| | Gear pump: 20 rpm | Gear pump: 10 rpm | gap: 1 mm | |
| | Material: UHMWiPP | Material: UHMPE/HDPE | Out put: 18.4-18.6 g/min | |
| 6 | Temp: 185° C. | Temp: 180° C. | Temp: 180° C. | Temp: |
| | Pressure: 1000 psi | Pressure: 1500 psi | Layer: 20layers | 10° C. |
| | Screw: 36 rpm | Screw: 48 rpm | Die lip width: 2″, | |
| | Gear pump rotation: 20 rpm | Gear pump: 10 rpm | gap: 1 mm | |
| | Material: UHMPE/HDPE | Material: UHMPE/HDPE | Output: 17.8-17.8 g/min | |
| 7 | Temp: 185° C. | Temp: 180° C. | Temp: 190° C. | Temp: |
| | Pressure: 2500 psi | Pressure: 2500 psi | Layer: 20layers | 10° C. |
| | Screw: 36 rpm | Screw: 46 rpm | Die lip width: 2″, | |
| | Gear pump: 20 rpm | Gear pump: 10 rpm | gap: 1 mm | |
| | Material: UHMPE/HDPE | Material: UHMPE/HDPE | Output: 19.0-18.5 g/min | |
| 8 | Temp: 185° C. | Temp: 180° C. | Temp: 190° C. | Temp: |
| | Pressure: 1100 psi | Pressure: 1500 psi | Layer: 20 layers | 10° C. |
| | Screw: 36 rpm | Screw: 46 rpm | Die lip width: 2″, | |
| | Gear pump: 20 rpm | Gear pump: 10 rpm | gap: 1 mm | |
| | Material: UHMWiPP | Material: UHMPE/HDPE | Output: 18.3-18.5 g/min | |

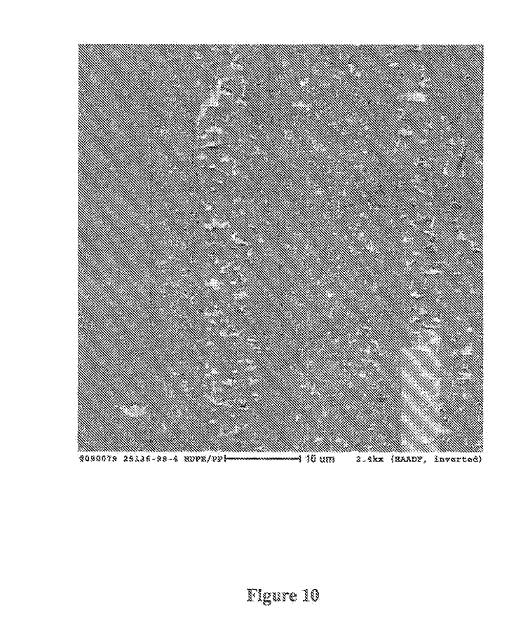

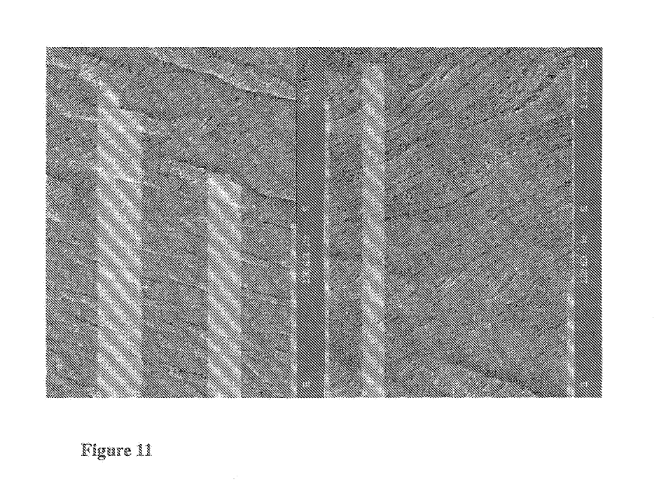

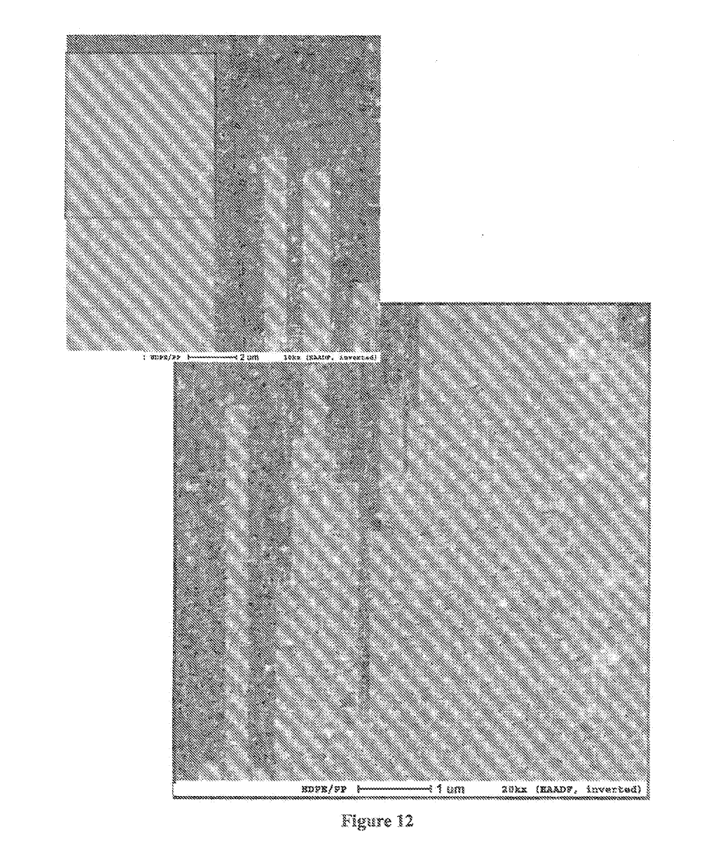

FIG. 9 shows an SEM image of a 20-layer extrudate such as Example 5 comprising PE layers separated by PP layers and having blend regions therebetween. FIG. 10 shows a micrograph of another 20 layer extrudate showing distinct layers of PE and PP along with blend regions. The layers and blend regions are generally less than 10 μm in this example. FIG. 11: Example of films having a row nucleated structure requiring less stretching to form a fibril structure, which is believed to provide a membrane with less internal stress and reduced shrinkage. FIG. 12 shows an exemplary film having iPP-rich region having iPP spherulites and transition layer of row nucleated and aligned iPP-containing layers.

### Comparative Example 1

The first and second mixtures of example 1 are coextruded to produce an eight-layer extrudate having seven blend regions. The conditions used to produce the first and second mixture are the same as those of example 1. The extrusion temperature is 210° C. Following co-extrusion, the extrudate is processed under the same conditions as Example 1, step (7) to produce a finished comparative membrane having a width of lm and a thickness of 80 μm. The elapsed time between the introduction of the first and second mixtures into the extruder and the cooling is 5 seconds.

### Properties

The properties of the multi-layer microporous membrane of Example 1 and Comparative Example 1 are measured by the procedures defined as follows. The results are shown in Table 2.

TABLE 2

| | Ex 1, | Comp Ex 1 | | Comp Ex 1 |
|---|---|---|---|---|
| | Cooled | Cooled | Ex 1, | Comparative |
| PROPERTIES | Extrudate | Extrudate | Membrane | Membrane |
| Thickness (μm) | 2000 | 2000 | 80 | 80 |
| Width. (m) | 0.04 | 0.04 | 1 | 1 |
| Layer Thickness | 250 | 250 | 10 | 10 |
| (μm) | | | | |
| I1 thickness (μm) | 32.75 | 81 | 1.29 | 3.2 |
| I4 thickness (μm) | 20.25 | 81 | 0.81 | 3.2 |
| β | 1.59 | 1.0 | 1.59 | 1.0 |
| Fibrous Structure | yes | no | yes | yes |

As can be seen in the Table, the cooled extrudate of the example has the desired fibrous structure whereas the cooled extrudate of the comparative example does not. Moreover, since the contact times of the layers produced during coextrusion is the same for each layer pair, the membrane of the comparative example contains blend regions of the same thickness. Consequently, the comparative membrane does not have a β in the desired range, i.e., β>1.

All patents, test procedures, and other documents cited herein, including priority documents, are fully incorporated by reference to the extent such disclosure is not inconsistent and for all jurisdictions in which such incorporation is permitted.

While the illustrative forms disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside herein, including all features which would be treated as equivalents thereof by those skilled in the art to which this disclosure pertains.

When numerical lower limits and numerical upper limits are listed herein, ranges from any lower limit to any upper limit are contemplated.

1. A layered microporous polymeric membrane comprising a first blend region having a thickness T1, a third blend region having a thickness T3, and a second blend region located between the first and third blend regions and having a thickness T2, wherein [(T1−T2)/T1]≧0.05 and [(T3−T2)/T3]≧0.05;

2. The layered microporous polymeric membrane of claim 1, wherein [(T1−T2)/T1] is in the range of 0.10 to 0.75 and [(T3−T2)/T3] is in the range of 0.10 to 0.75.

3. The layered microporous polymeric membrane of claim 1, wherein the membrane comprises at least two layers of a first polyolefin and at least two layers of a second polyolefin, the first polyolefin being different from the second polyolefin, wherein each layer containing the first polyolefin is separated from adjacent layers containing the second polyolefin by one of the blend regions.

4. The layered microporous polymeric membrane of claim 1, wherein the membrane comprises (i) first, second, third, and fourth layers, the first and third layers comprising a first polymer and the second and fourth layers comprising a second polymer, wherein the second polymer being different from the first polymer; and (ii) the first blend region being located between the first and second layers, the second blend region being located between the second and third layers, and the third blend region being located between the third and fourth layers.

5. The layered microporous polymeric membrane of claim 4, wherein the first and third layers have approximately equal thickness, the second and fourth layers have approximately equal thickness, and the first and third blend regions have approximately the same thickness.

6. The layered microporous polymeric membrane of claim 4, wherein the first polymer is not miscible with the second polymer.

7. The layered microporous polymeric membrane of claim 6, wherein the first polymer comprises polyethylene, and wherein the second polymer comprises polypropylene.

8. The layered microporous polymeric membrane of claim 7, wherein the membrane further comprises layers outward of the first layer, the fourth layer, or both, and wherein the membrane is a symmetric membrane having a symmetry plane within the second region.

9. The layered microporous polymeric membrane of claim 8, wherein each blend region has a thickness in the range of 15 nm to 10 μm, and each layer has a thickness in the range of 25 nm to 50 μm.

10. The layered microporous polymeric membrane of claim 8, wherein the first and second polymers are independently selected from one or more of UHMWPE, HDPE, and polypropylene having an Mw in the range of from about 1×10⁴ to about 4×10⁶ and a ΔHm in the range of 100 J/g to 120 J/g.

11. A microporous membrane, comprising
a) a first blend region comprising a first polymer and a second polymer and having a first concentration profile of the first polymer, or representation thereof, that varies in the thickness direction of the first blend region; and
b) a second blend region in surface contact with the first blend region (BL1) and comprising the first polymer and the second polymer and having a second concentration profile of the first polymer, or representation thereof, the second concentration varying in the thickness direction of the second blend region.

12. The membrane of claim 11, further comprising a first microporous microlayer having a thickness ≦1.0 μm, and a second microporous microlayer having a thickness ≦1.0 μm, wherein the first and second blend regions are located between the first and second microporous microlayers.

13. The membrane of claim 11, wherein the first polymer is selected from at least one of
a) a polyethylene having an Mw<1.0×10⁶ and a terminal vinyl content<0.20 per 10,000 carbon atoms;
b) a polyethylene having a molecular weight≧1.0×10⁶; and,
c) a polyethylene homopolymer of copolymer having a molecular weight ranging from 5×10³ to 2.0×10³ and a melting point ranging from 115.0° C. to 130.0° C.;
and the second polymer is selected from at least one of:
d) a polypropylene having an Mw≧1.0×10⁶ and a heat of fusion of ≧90 J/g; and
e) a polypropylene homopolymer or copolymer having a molecular weight ranging from 5×10³ to 2.0×10⁵ and a melting point ranging from 115.0° C. to 130.0° C.

14. The membrane of claim 11, wherein the first and second blend regions each have a thickness in the range of 25 nm to 0.5 μm.

15. A microporous membrane comprising a first polymer and a second polymer, wherein the composition of the first polymer varies continuously in the thickness direction from a first surface of the film to a second surface of the film.

16. A method for making a microporous membrane comprising:
a) manipulating a first layered article comprising first and second layers,
wherein the first layer comprises a first diluent and a first polymer,
wherein the second layer comprises a second diluent miscible with the first diluent and a second polymer different from the first polymer,
to produce a second layered article having an increased number of layers including first and second adjacent blend regions that include the first polymer composition and the second polymer composition; and
b) removing at least a portion of the first and second diluents from the second article to produce the microporous membrane.

17. The method of claim 16, wherein manipulating the first layered article includes reducing the thickness and increasing the width of at least a section of the first article before producing the second article.

18. The method of claim 16, wherein the layered article is a layered extrudate.

19. The method of claim 16, wherein the first and second polymers are immiscible.

20. The method of claim 16, wherein the first and second polymers are independently selected from one or more of UHMWPE, HDPE, and polypropylene haying an Mw in the range of from about 1×10⁴ to about 4×10⁶ and a ΔHm in the range of 100 J/g to 120 J/g.

21. The method of claim 16, wherein the first diluent is the same as the second diluent.

22. The method of claim 16, wherein the first and second diluents are liquid paraffin.

23. The method of claim 16, wherein the forming, manipulating, and molding are each conducted at a temperature in the range of Tm+10° C. to Tm+120° C.

24. The method of claim 16, wherein during the forming, manipulating, and molding, the first and second polymers and first and second diluents when combined have a diffusion coefficient D in the range of 10⁻¹¹ m²/sec to 10⁻¹⁵ m²/sec.

25. The method of claim 16, wherein each of the forming, manipulating, and molding are conducted for a time in the range of 0.5 seconds to 100 seconds.
